(19) United States
(12) Patent Application Publication
(10) Pub. No.: US 2015/0321198 A1
(43) Pub. Date: Nov. 12, 2015

(54) SHREDDING UNIT, SHREDDER USING THE SAME, AND SHEET-LIKE-OBJECT PROCESSING APPARATUS

(71) Applicant: SAKAE CO., LTD., Tokyo (JP)

(72) Inventors: Yukihiro TAKEDA, kodama-gun (JP); Yoshio MASUKO, kodama-gun (JP); Koichi MATSUMOTO, Fujioka-shi (JP)

(73) Assignee: SAKAE CO., LTD., Tokyo (JP)

(21) Appl. No.: 14/706,469

(22) Filed: May 7, 2015

(30) Foreign Application Priority Data
May 8, 2014 (JP) 2014-097173

(51) Int. Cl. B02C 18/00; B02C 18/18

(52) U.S. Cl. CPC B02C 18/0007; B02C 18/182; B02C 2018/0069

(57) ABSTRACT

Provided is a shredder that prevents particles from jamming in a shredding mechanism at the time of shredding sheet-like objects, and maintains shredding performance. A cleaning mechanism (10) for cleaning cutter elements (4) in a pair as a shredding mechanism (3) includes: first partition members (11) arranged in a plurality of stages to cover peripheries of spacer portions (6) of the cutter elements (4) in a pair, the first partition members (11) being configured to remove particles (1a) from an inside of recessed portions (7) of the cutter elements (4) in a pair; and second partition members (12) arranged in a plurality of stages to cover peripheries of cutter portions (5) of the cutter elements (4) in a pair, the second partition members (12) being configured to close gaps through which the particles (1a) enter between the first partition members (11).

### BACKGROUND OF THE INVENTION

1. Field of the Invention

The present invention relates to a shredding unit for shredding sheet-like objects, a shredder using the shredding unit, and to a sheet-like-object processing apparatus.

2. Description of the Related Art

As shredders in the related art, shredders as described in Japanese Patent Application Laid-open No. 2000-354784 (Embodiment and FIG. 6) and Japanese Patent Application Laid-open No. 2009-131750 (Best Mode for carrying out the Invention and FIG. 1) have already been known.

The shredder disclosed in Japanese Patent Application Laid-open No. 2000-354784 (Embodiment and FIG. 6) includes entrapment preventing guide members for preventing particles to be discharged from spaces between rotary blades from being entrapped or fed back along outer surface portions of rotary shafts. The entrapment preventing guide members are interposed and fixed between the rotary blades. Prior to the interposition of the guide members between the rotary blades, each of the guide members is in a deformed state in which a facing distance between distal ends of a surrounding inner rim is large, that is, the surrounding inner rim is opened by a widthwise deformable cutout portion. In this manner, the guide members are inserted between the rotary blades through the space between the distal ends from an outer side of the rotary shafts, and then clamped. With this, the distance between the distal ends of the surrounding inner rim is reduced by the widthwise deformable cutout portion. In this closed state, the surrounding inner rim is maintained in a surrounding state, specifically, maintained to fit and cover an outer peripheral range that is at least equal to or larger than a semicircular region of corresponding one of the outer surface portions.

The shredder disclosed in Japanese Patent Application Laid-open No. 2009-131750 (Best Mode for carrying out the Invention and FIG. 1) includes a pair of roller cutters each including cutter discs and spacers that are stacked alternately to each other. The pair of roller cutters are engaged in parallel with each other so that the cutter discs on one side are fitted into spaces between the cutter discs on another side in a meshing state. Edge portions are formed so as to project in a radial direction from an outer peripheral surface of each of the cutter discs and the spacers, and in meshing portions therebetween, the edge portions of the cutter discs on the one side and the edge portions of the spacers on the another side are held in sliding contact with each other. With this, in the meshing portions, sheets that have been vertically shredded are cut in a manner of being torn apart upward and downward by the edge portions.

However, in the shredders of this type, shredding sizes of sheet-like objects are determined based on various security levels in accordance with demand from users, and shredding mechanisms corresponding thereto are employed.

In recent years, according to a DIN standard set by a standard organization in Germany (DIN 66399, set in September 2012), out of seven security levels that are classified in accordance with shredding dimensions, Security Level 7 is specified as the highest level (shredding dimension: area of 5.0 mm² or less). Along with increase in security level on the shredding size of the particles, a clearance between cutter elements of the shredding mechanism (for example, the cutter discs of the pair of roller cutters as disclosed in Japanese Patent Application Laid-open No. 2009-131750 (Best Mode for carrying out the Invention and FIG. 1)) needs to be reduced inevitably.

In such circumstances, the shredder includes, for example, the guide members as disclosed in Japanese Patent Application Laid-open No. 2000-354784 (Embodiment and FIG. 6) so that the particles generated through shredding by the shredding mechanism are not entrapped by the cutter elements. However, along with reduction in size of the particles generated through the shredding by the shredding mechanism, the particles of a small size are liable to enter a gap between the guide members. When the particles are accumulated, there is a risk of trouble with a rotational operation of the cutter elements of the shredding mechanism.

To avoid such a situation, for example, there is given a method of periodically supplying oil to the cutter elements of the shredding mechanism to reduce frictional resistance between the cutter elements and the particles on a periphery of the cutter elements.

However, oil supply means is essential for this type of method, and there remains a risk of such a situation that the particles entering the narrow gap between the guide members in a state of being separated from the cutter elements are accumulated.

### SUMMARY OF THE INVENTION

It is a technical object of the present invention to provide a shredding unit, a shredder using the shredding unit, and a sheet-like-object processing apparatus, which are capable of preventing particles from jamming in a shredding mechanism at the time of shredding sheet-like objects, and maintaining shredding performance of the shredding mechanism over a long time period.

According to a first technical feature of the present invention, there is provided a shredding unit for shredding a sheet-like object, the shredding unit including: a shredding mechanism including cutter elements in a pair, which are arranged to mesh with each other, for shredding the sheet-like object conveyed into a meshing region between the cutter elements in a pair; and a cleaning mechanism for cleaning the cutter elements in a pair to remove, from the cutter elements in a pair, particles generated through shredding in the meshing region between the cutter elements in a pair, the shredding mechanism including, as each of the cutter elements in a pair: cutter portions each having a circular shape in cross-section with cutting blades formed therearound at a predetermined pitch, the cutter portions being arranged in a plurality of stages through intermediation of spacer portions each having a circular shape in cross-section with a predetermined clearance; and recessed portions formed between the cutter portions so that the cutting blades of the cutter portions project outward with respect to peripheries of the spacer portions, the cutting blades of the cutter portions of one of the cutter elements in a pair meshing with the recessed portions of another of the cutter elements in a pair in a manner of biting into the recessed portions, the cleaning mechanism including: first partition members arranged in a plurality of stages in a region out of the meshing region between the cutter elements in a pair to cover the peripheries of the spacer portions of the cutter elements in a pair, the first partition members being configured to remove the particles generated through the shredding in the meshing region between the cutter elements in a pair from an inside of the recessed portions of the cutter elements in a pair; and second partition members arranged in a plurality of stages in the region out of the meshing region between the cutter elements in a pair to cover peripheries of the cutter portions of the cutter elements in a pair, the second partition members being configured to close gaps through which the particles generated through the shredding in the meshing region between the cutter elements in a pair enter between the first partition members.

According to a second technical feature of the present invention, in the shredder unit having the first technical feature, the shredding mechanism includes, as the each of the cutter elements in a pair, a blade drum including the cutter portions integrally formed around a rotatable drum body by a cutting-out process through intermediation of the recessed portions each having a predetermined clearance along a direction of a rotary shaft of the rotatable drum body.

According to a third technical feature of the present invention, in the shredder unit having the first technical feature, the first partition members and the second partition members of the cleaning mechanism are arranged in a plurality of stages so that the first partition members and the second partition members are alternately stacked along the spacer portions and the cutter portions of the cutter elements in a pair, which are arranged in the shredding mechanism, and the first partition members and the second partition members are positioned by positioning members.

According to a fourth technical feature of the present invention, in the shredder unit having the first technical feature, each of the first partition members of the cleaning mechanism has a circular-arc edge surface conforming to a shape of a peripheral surface of each of the spacer portions of the cutter elements in a pair, and each of the second partition members of the cleaning mechanism has a circular-arc edge surface conforming to an outer peripheral edge of each of the cutting blades of the cutter portions of the cutter elements in a pair.

According to a fifth technical feature of the present invention, in the shredder unit having the first technical feature, each of the first partition members and the second partition members of the cleaning mechanism includes a plate member that bridges one half region and another half region defined across a boundary corresponding to a center position of the meshing region between the cutter elements in a pair, which are arranged in the shredding mechanism.

According to a sixth technical feature of the present invention, in the shredder unit having the first technical feature, the first partition members and the second partition members of the cleaning mechanism are positioned by a common positioning member.

According to a seventh technical feature of the present invention, in the shredder unit having the first technical feature, each of the first partition members and the second partition members of the cleaning mechanism is positioned at two points including a portion to be positioned, which is a pivot center, and a portion to be positioned, which is formed at a position separated from the pivot center.

According to a eighth technical feature of the present invention, in the shredder unit having the first technical feature, each of the first partition members of the cleaning mechanism includes one or a plurality of guide pieces extending downward, which are formed at a lower end edge of a part of the each of the first partition members for covering each of the peripheries of the spacer portions of the cutter elements in a pair.

According to a ninth technical feature of the present invention, there is provided a shredder, including: a shredder casing; a conveying path formed in the shredder casing, for conveying a sheet-like object; and a shredding unit arranged in a midway of the conveying path, for shredding the conveyed sheet-like object, the shredding unit including the shredding unit having the first technical feature.

According to a tenth technical feature of the present invention, in the shredder having the ninth technical feature, further including: a trash container arranged below the shredding mechanism inside the shredder casing, for receiving shreds formed of the particles generated through the shredding by the shredding mechanism; and a movable support mechanism for supporting the trash container so that the trash container is drawable out of the shredder casing, the movable support mechanism including: a receiving member having a tray-like shape, on which the trash container is mountable; and a guide mechanism arranged on a bottom portion of the shredder casing, for guiding the receiving member so that the receiving member is drawable out of the shredder casing under a state in which at least a part of the guide mechanism is held in contact with an installation surface of the shredder.

According to a eleventh technical feature of the present invention, in the shredder having the tenth technical feature, the guide mechanism includes: a guide rail for guiding the receiving member along a drawing direction; and a guide roller arranged on a front side in the drawing direction of the receiving member, for supporting and guiding the front side in the drawing direction of the receiving member and rolling with respect to the installation surface of the shredder when drawing the receiving member out of the shredder casing.

According to a twelfth technical feature of the present invention, there is provided a sheet-like-object processing apparatus, including: a processing unit for processing a sheet-like object; and the shredder having the ninth technical feature for shredding the sheet-like object that fails to be properly processed by the processing unit.

According to the first technical feature of the present invention, at the time of shredding the sheet-like objects, the jam of the particles in the shredding mechanism can be prevented, and hence shredding performance of the shredding mechanism can be maintained over a long time period.

According to the second technical feature of the present invention, in comparison with an aspect in which the configuration of the present invention is not provided, at the time of shredding the sheet-like objects, the sheet-like objects can be shredded into such an extremely small size that the sheet-like objects cannot be reproduced.

According to the third technical feature of the present invention, the cleaning mechanism including the first and second partition members can be easily set on the shredding mechanism.

According to the fourth technical feature of the present invention, in comparison with the aspect in which the configuration of the present invention is not provided, a particle removal action and a particle accumulation preventing action by the cleaning mechanism can be performed over a wider range.

According to the fifth technical feature of the present invention, in comparison with the aspect in which the configuration of the present invention is not provided, cleaning performance of the cleaning mechanism can be enhanced.

According to the sixth technical feature of the present invention, in comparison with the aspect in which the configuration of the present invention is not provided, the positioning of the cleaning mechanism with respect to the shredding mechanism can be realized accurately.

According to the seventh technical feature of the present invention, in comparison with the aspect in which the configuration of the present invention is not provided, a relative positional relationship of the cleaning mechanism with respect to the shredding mechanism can be maintained accurately.

According to the eighth technical feature of the present invention, in comparison with the aspect in which the configuration of the present invention is not provided, the particle removal action by the cleaning mechanism can be performed more reliably.

According to the ninth technical feature of the present invention, it is possible to provide the shredder including the shredding unit, which is capable of preventing the particles from jamming in the shredding mechanism at the time of shredding the sheet-like objects, and maintaining the shredding performance of the shredding mechanism over a long time period.

According to the tenth technical feature of the present invention, a post-process on the shreds generated through the shredding by the shredding mechanism can be performed easily.

According to the eleventh technical feature of the present invention, in comparison with the aspect in which the configuration of the present invention is not provided, the trash container together with the receiving member can be stably drawn out of the shredder casing.

According to the twelfth technical feature of the present invention, it is possible to provide the sheet-like-object processing apparatus including the shredder, which is capable of preventing the particles from jamming in the shredding mechanism at the time of shredding the sheet-like objects, and maintaining the shredding performance of the shredding mechanism over a long time period.

### BRIEF DESCRIPTION OF THE DRAWINGS

FIG. 1A is an explanatory view of an outline of a shredder according to an embodiment of the present invention.

FIG. 1B is an explanatory view of a main part of a shredding unit to be used in the embodiment of the present invention.

FIG. 1C is an explanatory sectional view taken along the line C-C in FIG. 1B.

FIG. 2A is a schematic explanatory view of behavior of shredding sheet-like objects in a meshing region of a shredding mechanism of the shredding unit.

FIG. 2B is an explanatory view of a principle of cleaning off particles by a cleaning mechanism of the shredding unit to be used in the embodiment of the present invention.

FIG. 2C is an explanatory view of a principle of cleaning off particles by a cleaning mechanism of a shredding unit to be used in a comparative example.

FIG. 3 is an explanatory view of a preferred example of a trash container drawing mechanism to be used in the embodiment of the present invention.

FIG. 4 is an explanatory view of an overall configuration of a shredder according to a first embodiment of the present invention.

FIG. 5A is an explanatory view of a main part of the shredder according to the first embodiment.

FIG. 5B is an explanatory view of an example of a drive device for a shredding mechanism of a shredding unit.

FIG. 6A is a detailed explanatory view of the shredding unit to be used in the first embodiment.

FIG. 6B is a detailed explanatory view of a meshing region between blade drums in a pair.

FIG. 7A is a schematic explanatory view of a positional relationship between components of the shredding unit.

FIG. 7B is an explanatory view of a main part of the blade drums in a pair.

FIG. 7C is an explanatory view of a relative positional relationship in the meshing region between the blade drums in a pair.

FIG. 8A is an explanatory view of a configuration example of a first partition member of a cleaning mechanism.

FIG. 8B is a detailed view of the part B in FIG. 8A.

FIG. 9A is an explanatory view of the configuration example of the first partition member of the cleaning mechanism.

FIG. 9B is an explanatory view of a configuration example of a second partition member of the cleaning mechanism.

FIG. 10A is an explanatory view of an arrangement relationship between the blade drums of the shredding mechanism and the first partition members of the cleaning mechanism.

FIG. 10B is an explanatory view of an arrangement relationship between the blade drums of the shredding mechanism and the second partition members of the cleaning mechanism.

FIG. 11A to FIG. 11C are explanatory views of an assembly process of the shredding unit.

FIG. 12A is a schematic explanatory perspective view of a main part of the shredding unit according to the first embodiment.

FIG. 12B is an explanatory sectional view of the main part of the shredding unit according to the first embodiment.

FIG. 13A is a schematic explanatory perspective view of a main part of a shredding unit according to Comparative Example 1.

FIG. 13B is an explanatory sectional view of the main part of the shredding unit according to Comparative Example 1.

FIG. 14 is a flowchart of steps of a shredding control process by a control device to be used in the first embodiment.

FIG. 15A is a graph of a relationship between electric current of a motor as a drive source and the number of fed sheets.

FIG. 15B is an explanatory graph of a difference in temporal change of the electric current of the motor at the time of starting driving between an initial use stage of the shredder and a sheet jam stage in the shredding mechanism.

FIG. 15C is an explanatory graph of a difference in temporal change of the electric current of the motor after completion of the shredding between the initial use stage of the shredder and the sheet jam stage in the shredding mechanism.

FIG. 16 is a graph of an example of operation of a cleaning mode to be used in the first embodiment.

FIG. 17A is an explanatory view of a main part of a shredding unit according to a first modification of the present invention.

FIG. 17B is an explanatory view of a main part of a shredding unit according to a second modification of the present invention.

FIG. 18 is an explanatory view of an outline of a trash container drawing mechanism to be used in a shredder according to a second embodiment of the present invention.

FIG. 19 is an explanatory view of a state in which the trash container drawing mechanism to be used in the second embodiment is arranged inside a shredder casing.

FIG. 20 is an explanatory view of a state in which the trash container drawing mechanism to be used in the second embodiment is drawn out of the shredder casing.

FIG. 21 is an enlarged explanatory view of the part XXI in FIG. 20.

FIG. 22A is a schematic explanatory view of behavior of a guide mechanism of the trash container drawing mechanism.

FIG. 22B is an explanatory view of a configuration of a guide roller of the trash container drawing mechanism.

FIG. 23 is a schematic explanatory view of an operation process of the trash container drawing mechanism according to the first embodiment.

FIG. 24 is an explanatory view of a main part of an image forming apparatus as a sheet-like-object processing apparatus according to a third embodiment of the present invention.

### DETAILED DESCRIPTION OF THE PREFERRED EMBODIMENTS

Outline of Embodiments of Present Invention

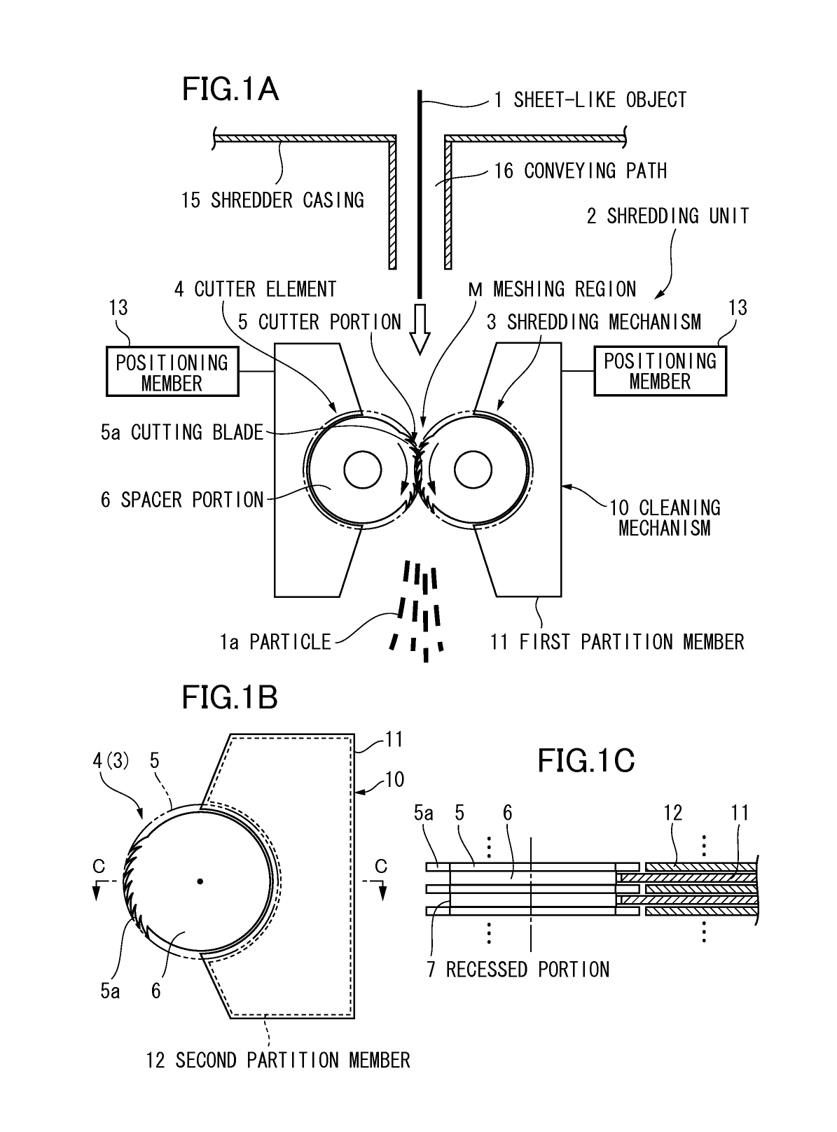

FIG. 1A is an illustration of an outline of a shredder according to an embodiment of the present invention.

In FIG. 1A, the shredder includes a shredder casing 15, a conveying path 16 formed in the shredder casing 15, for conveying a sheet-like object 1, and a shredding unit 2 arranged in a midway of the conveying path 16, for shredding the conveyed sheet-like object 1.

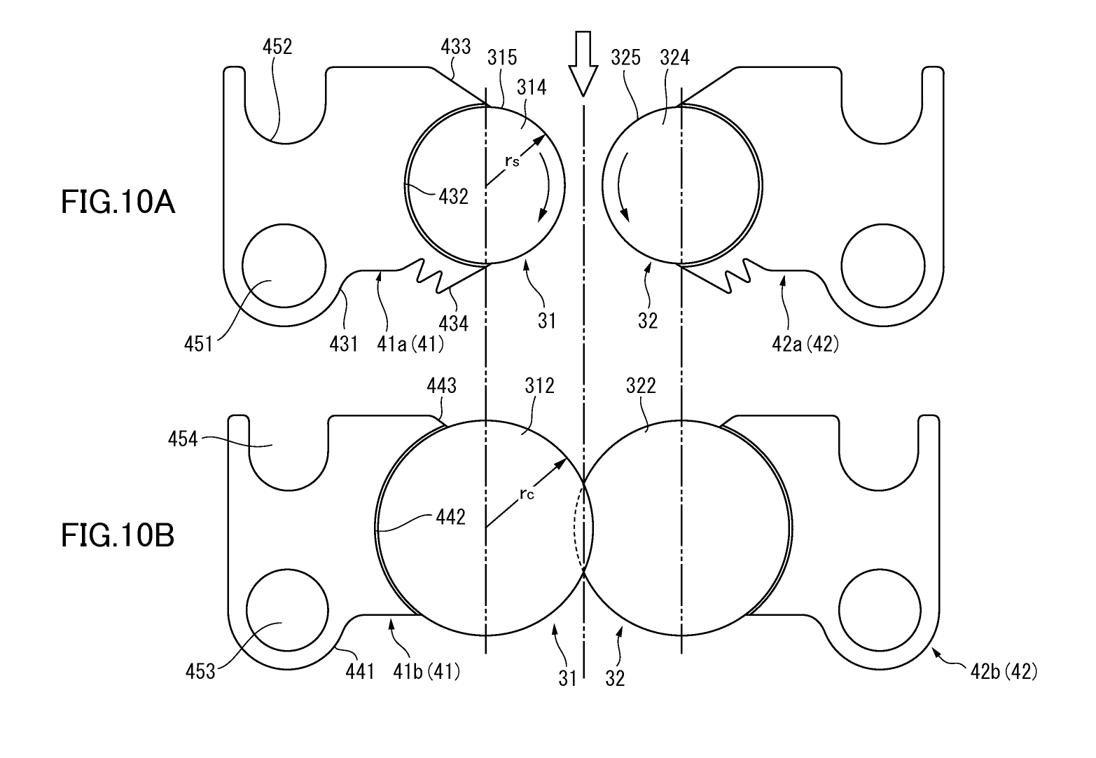

In addition, as illustrated in FIG. 1A to FIG. 1C, the shredding unit 2 includes a shredding mechanism 3 including cutter elements 4 arranged in a pair to mesh with each other, for shredding the sheet-like object 1 conveyed into a meshing region M between the cutter elements 4 in a pair, and a cleaning mechanism 10 for cleaning the cutter elements 4 to remove, from the cutter elements 4, particles 1a generated through shredding in the meshing region M between the cutter elements 4 in a pair. The shredding mechanism 3 includes, as each of the cutter elements 4 in a pair, cutter portions 5 each having a circular shape in cross-section with cutting blades 5a formed therearound at a predetermined pitch, the cutter portions 5 being arranged in a plurality of stages through intermediation of spacer portions 6 each having a circular shape in cross-section with a predetermined clearance, and recessed portions 7 (see FIG. 10) formed between the cutter portions 5 so that the cutting blades 5a of the cutter portions 5 project outward with respect to peripheries of the spacer portions 6. The cutting blades 5a of the cutter portions 5 of one of the cutter elements 4 mesh with the recessed portions 7 of another of the cutter elements 4 in a manner of biting into the recessed portions 7. The cleaning mechanism 10 includes first partition members 11 arranged in a plurality of stages in a region out of the meshing region M between the cutter elements 4 in a pair to cover the peripheries of the spacer portions 6 of the cutter elements 4, the first partition members 11 being configured to remove the particles 1a generated through the shredding in the meshing region M between the cutter elements 4 in a pair from an inside of the recessed portions 7 of the cutter elements 4, and second partition members 12 arranged in a plurality of stages in the region out of the meshing region M between the cutter elements 4 in a pair to cover peripheries of the cutter portions 5 of the cutter elements 4, the second partition members 12 being configured to close gaps through which the particles 1a generated through the shredding in the meshing region M between the cutter elements 4 in a pair enter between the first partition members 11.

In such technical means, each of the cutter elements 4 in a pair as the shredding mechanism 3 is only required to include the cutter portions 5 arranged in a plurality of stages through intermediation of the spacer portions 6, and the recessed portions 7 formed by the cutting blades 5a of the cutter portions 5 and the spacer portions 6. In addition, both the cutter elements 4 are only required to be constructed such that the cutting blades 5a of the cutter portions 5 of one of the cutter elements 4 mesh with the recessed portions 7 of another of the cutter elements 4 in a manner of biting into the recessed portions 7. Further, each of the cutter elements 4 in a pair may be constructed by stacking cutter discs as the cutter portions 5 and spacer discs as the spacer portions 6 alternately along a rotary shaft, or by integrally forming the cutter portions 5 and the spacer portions 6 as a blade drum.

Besides, the first partition members 11 as the cleaning mechanism 10 may be formed into any shape as long as the first partition members 11 cover the peripheries of the spacer portions 6 of the cutter elements 4 and remove the particles 1a from the inside of the recessed portions 7 (peripheral surfaces of the spacer portions 6).

Further, the second partition members 12 may be formed into any shape as long as the second partition members 12 cover the peripheries of the cutter portions 5 of the cutter elements 4 and close the gaps through which the particles 1a enter between the first partition members 11.

Note that, in order to reduce the shredding size, the clearances between the cutter portions 5 and between the spacer portions 6 are reduced. Thus, the first and second partition members 11 and 12 are inevitably thinned. For this reason, it is preferred that the partition members 11 and 12 be formed into a plate-like shape so that a surface rigidity is secured.

In this embodiment, the cleaning mechanism 10 is appropriately designed to prevent the particles 1a from being accumulated on a periphery of the shredding mechanism 3, and hence shredding performance of the shredding mechanism 3 can be maintained. For this reason, an oil supply system may be employed to maintain the shredding performance of the shredding mechanism 3, but there is substantially no need to perform oil supply.

Further, in this embodiment, considering occurrence of a situation where cleaning performance of the cleaning mechanism 10 is impaired, such measures may be taken as necessary that a control device includes a determination unit for determining a jam condition of the particles 1a in the shredding mechanism 3.

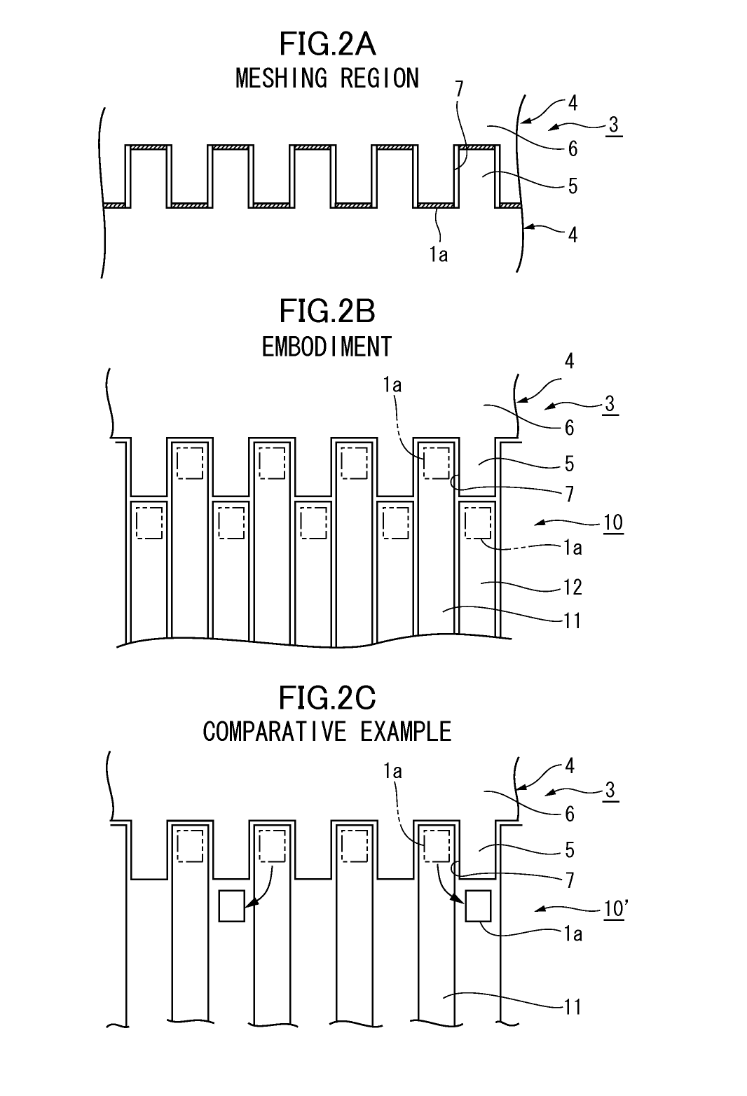

According to this embodiment, as illustrated in FIG. 2A, the shredding mechanism 3 of the shredding unit 2 shreds the sheet-like object 1 in the meshing region M between the cutter elements 4 in a pair, and most of the particles 1a generated through the shredding fall downward to be received in a trash container (not shown).

At this time, as indicated by the two-dot chain line in FIG. 2B, a part of the particles 1a generated through the shredding in the meshing region M between the cutter elements 4 in a pair may electrostatically adhere to the cutter portions 5 of the cutter elements 4 and the spacer portions 6 between the cutter portions 5 without falling downward after passing through the meshing region M between the cutter elements 4.

However, in this embodiment, the cleaning mechanism 10 includes the first partition members 11 arranged at parts corresponding to the spacer portions 6 of the cutter elements 4, and the second partition members 12 arranged at parts corresponding to the cutter portions 5 of the cutter elements 4. Thus, the particles 1a electrostatically adhering to the spacer portions 6 are scraped off by the first partition members 11 to fall downward, whereas the particles 1a electrostatically adhering to the cutter portions 5 are scraped off by the second partition members 12 to fall downward.

Therefore, the particles 1a generated through the shredding in the meshing region M between the cutter elements 4 fall downward without being accumulated on the cutter elements 4.

In this respect, according to, for example, a comparative example of FIG. 2C (example in which a cleaning mechanism 10′ including only the first partition members 11 without the second partition members 12 is provided), the first partition members 11 are arranged at parts corresponding to the spacer portions 6 of the cutter elements 4, and hence the particles la electrostatically adhering to the spacer portions 6 are scraped off by the first partition members 11 to fall downward. However, when the particles 1a become finer to some extent, the particles 1a electrostatically adhering to the cutter portions 5 may remain as they are.

That is, when the particles 1a are large to some extent, most of the particles 1a electrostatically adhering to the cutter portions 5 of the cutter elements 4 are caught by the first partition members 11, and hence the particles 1a exhibit such behavior that the particles 1a are scraped off by the first partition members 11 to fall downward. When the particles 1a become finer to some extent, a situation where the particles 1a electrostatically adhering to the cutter portions 5 of the cutter elements 4 are not caught by the first partition members 11 is liable to occur. This situation may cause a risk in that the particles 1a are liable to be accumulated on the peripheries of the cutter portions 5 of the cutter elements 4.

Next, description is made of typical examples or preferred examples of the shredder according to embodiments of the present invention.

First, as a preferred example of the shredding mechanism 3, there is given a configuration in which a blade drum including the cutter portions 5 integrally formed around a rotatable drum body by a cutting-out process through intermediation of the recessed portions 7 each having a predetermined clearance along a direction of a rotary shaft of the drum body is used as each of the cutter elements 4 in a pair.

In this example, the blade drum is constructed such that the cutter portions 5 each having the cutting blades 5a formed thereon are arrayed around the drum body through intermediation of the recessed portions 7. In order to shred an object into an extremely small size, the cutter portions 5 are extremely thinned, and hence positional accuracy thereof is difficult to secure even when a plurality of cutter discs are stacked. Therefore, this example employs a manufacturing method involving integrally forming the cutter portions 5 by the cutting-out process around a drum body made of a reinforcing material such as carbon steel. In this case, it is preferred that the cutting blades 5a of the cutter portions 5 be subjected to a polishing process from the viewpoint of securing sufficient cutting performance.

Further, the cutting blades 5a of the cutter portions 5 are only required to be formed at the predetermined pitch, which corresponds to a length dimension of one side of each of the rectangular particles of the sheet-like object 1. Further, the clearance of each of the recessed portions 7 between the cutter portions 5 corresponds to a length dimension of another side of each of the rectangular particles.

Further, as atypical example of the cleaning mechanism 10, there is given a configuration in which the first and second partition members 11 and 12 are arranged in a plurality of stages so that the first and second partition members 11 and 12 are alternately stacked along the spacer portions 6 and the cutter portions 5 of the cutter elements 4 in a pair, which are arranged in the shredding mechanism 3, and the first and second partition members 11 and 12 are positioned by positioning members 13.

In this example, the first and second partition members 11 and 12 are positioned after being arranged in a plurality of stages by the stacking method.

Besides, as another typical example of the cleaning mechanism 10, there is given a configuration in which each of the first partition members 11 has a circular-arc edge surface conforming to a shape of the peripheral surface of each of the spacer portions 6 of the cutter elements 4 in a pair, and each of the second partition members 12 has a circular-arc edge surface conforming to an outer peripheral edge of each of the cutting blades 5a of the cutter portions 5 of the cutter elements 4 in a pair.

In this example, the edge surface of each of the first partition members 11 is formed into the circular-arc surface conforming to the shape of the peripheral surface of each of the spacer portions 6 of the cutter elements 4. Thus, the particles 1a accumulated on the peripheral surfaces of the spacer portions 6 (corresponding to bottom surfaces of the recessed portions 7) are brought into contact with the wide edge surfaces of the first partition members 11 and therefore removed by their frictional resistance.

Meanwhile, each of the second partition members 12 is arranged to close the gap between the first partition members 11, and the edge surface of each of the second partition members 12 is formed into the circular-arc surface conforming to the outer peripheral edge of each of the cutting blades 5a of the cutter portions 5 of the cutter elements 4. Thus, even when the particles 1a removed by the first partition members 11 are to be shifted to vicinities of the cutter portions 5 of the cutter elements 4, the particles la are not accumulated on the vicinities of the cutter portions 5 because the gaps through which the particles 1a enter the vicinities of the cutter portions 5 are closed.

Further, as preferred examples of the cleaning mechanism 10, for example, the following four configurations are given.

As a first preferred example, there is given a configuration in which each of the first and second partition members 11 and 12 is formed of a plate member that bridges one half region and another half region defined across a boundary corresponding to a center position of the meshing region M between the cutter elements 4 in a pair, which are arranged in the shredding mechanism 3. In this example, each of the first and second partition members 11 and 12 covers the regions other than the meshing region M between the cutter elements 4 in a pair over a wide range. Therefore, this example is preferred in that the particles 1a are less liable to be accumulated on the peripheries of the cutter elements 4.

As a second preferred example, there is given a configuration in which the first and second partition members 11 and 12 are positioned by a common positioning member 13. In this example, the first and second partition members 11 and 12 are positioned by the common positioning member 13, and hence this example is preferred in that a positional relationship between the first and second partition members 11 and 12 is accurately maintained.

As a third preferred example, there is given a configuration in which each of the first and second partition members 11 and 12 is positioned at two points including a portion to be positioned (not shown), which is a pivot center, and a portion to be positioned (not shown), which is formed at a position separated from the pivot center. In this example, each of the first and second partition members 11 and 12 is positioned with respect to the shredding mechanism 3 in a fixed manner because each of the first and second partition members 11 and 12 is positioned at two points. Therefore, in comparison with an example in which each of the first and second partition members 11 and 12 is positioned at one point, this example is preferred in that a relative positional relationship between the shredding mechanism 3 and the cleaning mechanism 10 becomes more accurate.

As a fourth preferred example, there is given a configuration in which each of the first partition members 11 includes one or a plurality of guide pieces (not shown) extending downward, which are formed at a lower end edge of a part of each of the first partition members 11 for covering each of the peripheries of the spacer portions 6 of the cutter elements 4 in a pair. In this example, each of the first partition members 11 includes the one or the plurality of guide pieces, and hence this example is preferred in that the particles 1a accumulated on the peripheral surfaces of the spacer portions 6 of the cutter elements 4 are removed by the first partition members 11 and the removed particles 1a are guided downward by the guide pieces.

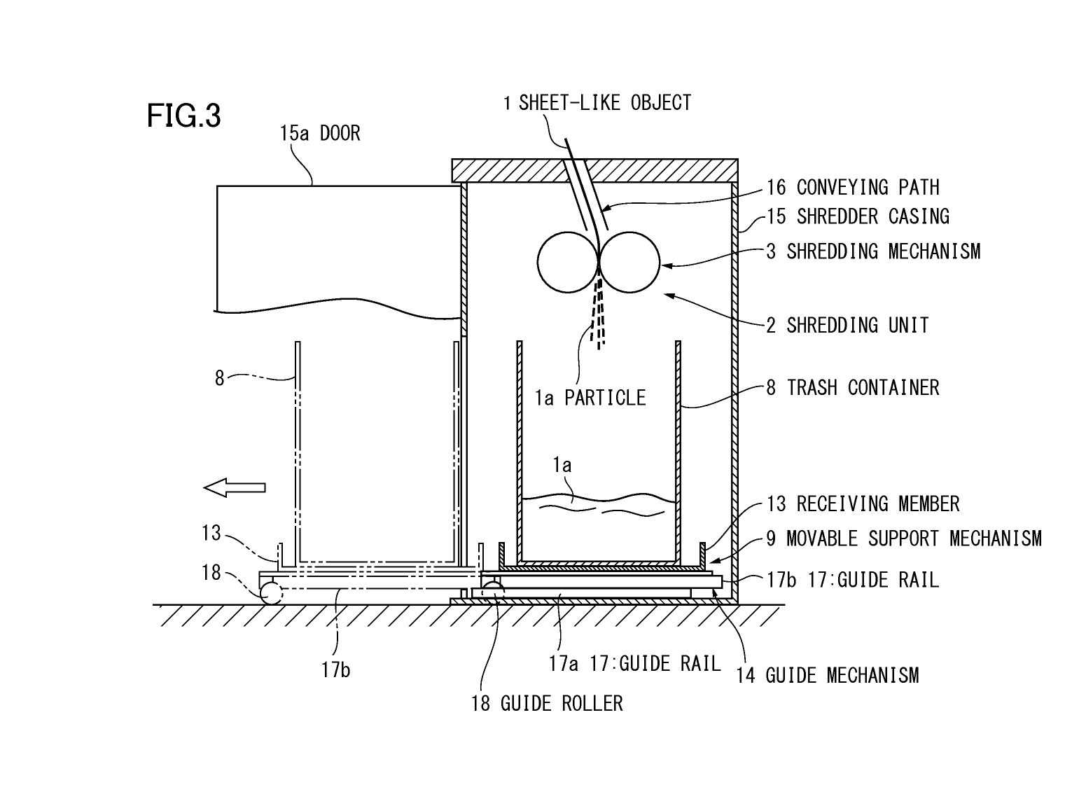

Further, as a preferred trash receiving structure of this embodiment, as illustrated in FIG. 3, there is given a trash receiving structure including a trash container 8 arranged below the shredding mechanism 3 inside the shredder casing 15, for receiving shreds formed of the particles 1a generated through the shredding by the shredding mechanism 3, and a movable support mechanism 9 for supporting the trash container 8 so that the trash container 8 is drawable out of the shredder casing 15, the movable support mechanism 9 including a receiving member 13 having a tray-like shape, on which the trash container 8 is mountable, and a guide mechanism 14 arranged on a bottom portion of the shredder casing 15, for guiding the receiving member 13 so that the receiving member 13 is drawable out of the shredder casing 15 under a state in which at least apart of the guide mechanism 14 is held in contact with an installation surface of the shredder. Note that, the cleaning mechanism 10 of the shredding unit 2 is omitted from FIG. 3. A door 15a is configured to open and close the shredder casing 15.

In this example, a box-shaped container is typically used as the trash container 8, but any other shape such as a bag shape may be employed as long as the shreds can be received in the container.

Besides, the movable support mechanism 9 is only required to include at least the receiving member 13 and the guide mechanism 14.

In this case, it is preferred to employ a configuration in which the receiving member 13 has a receiving surface with an area larger than the setting area of the trash container 8. Further, the guide mechanism 14 is only required to include a functional member for guiding the receiving member 13 in a drawable manner, and also include a functional member for supporting the receiving member 13 under a state in which at least a part of the functional member is held in contact with the installation surface of the shredder. Note that, it is preferred that the contact area and the contact resistance of the functional member held in contact with the installation surface of the shredder be smaller so that an unnecessary operation force is not applied at the time of an operation of drawing out and pushing in the receiving member 13.

Further, as a typical example of the guide mechanism 14, there is given a configuration in which the guide mechanism 14 includes a guide rail 17 for guiding the receiving member 13 along a drawing direction, and a guide roller 18 arranged on a front side in the drawing direction of the receiving member 13, for supporting and guiding the front side in the drawing direction of the receiving member 13 and rolling with respect to the installation surface of the shredder when drawing the receiving member 13 out of the shredder casing 15.

In this case, it is only necessary that, for example, a rail member extending in the drawing direction of the receiving member 13 be used as the guide rail 17, that the guide rail 17 include guide rail elements 17a and 17b in a pair, which are engaged with each other at a position between the bottom portion of the shredder casing 15 and the receiving member 13, and that the guide rail element 17b on one side be arranged on the guide rail element 17a on another side in a slidable manner. Note that, as the guide rail elements 17a and 17b in a pair, it is only necessary to arrange guide rail elements 17a and 17b corresponding respectively to the shredder casing 15 side and the receiving member 13 side. From the viewpoint of securing a large drawing amount for the trash container 8, it is preferred to employ a configuration in which at least one of the guide rail elements is arranged to be drawable in a plurality of stages.

Further, the guide roller 18 supports and guides the front side in the drawing direction of the receiving member 13, and hence, even when the receiving member 13 is drawn out of the shredder casing 15, there is no such risk that the receiving member 13 is drawn out under a state in which the front side in the drawing direction of the receiving member 13 is held in contact with the installation surface of the shredder.

Besides, as a preferred example of the guide mechanism 14, there is given a configuration in which the guide mechanism 14 includes a mounting base on which the receiving member 13 is mounted in a separable manner, and a part of the guide rail 17 (for example, 17b) and the guide roller 18 are arranged on the mounting base. As in this example, in the configuration in which the guide mechanism 14 includes the mounting base for the receiving member 13, the receiving member 13 on the mounting base can be separated after the mounting base is drawn out of the shredder casing 15. As a result, the cleaning of the inside of the receiving member 13 is facilitated.

Still further, as another preferred example of the guide mechanism 14, there is given a configuration in which the part of the guide rail 17 (for example, 17b) and the guide roller 18 are arranged on the receiving member 13.

In this example, the part of the guide rail 17 and the guide roller 18 are arranged on the receiving member 13, and hence the receiving member 13 cannot be separated but is drawn out of the shredder casing 15. Therefore, the receiving member 13 can be cleaned in a wide space on the outside of the shredder casing 15.

As a matter of course, the shredder described above may be independently used. However, the present application is not limited thereto, and includes a sheet-like-object processing apparatus in which this shredder is installed.

As an example of sheet-like-object processing apparatus of this type, there may be provided a sheet-like-object processing apparatus including a processing unit (not shown) for processing the sheet-like object 1, and the shredder configured to shred the sheet-like object 1 in a case where a process by this processing unit has failed to be properly executed on the sheet-like object 1. Examples of this processing unit may include functional portions of any type as long as the sheet-like object 1 may be processed. Specifically, in a case where the sheet-like object 1 is a recording material such as a sheet, an image forming unit for forming images, or a post-processing unit for executing, for example, a folding process on the recording material serves as the processing unit.

Now, description is made of embodiments of the present invention in more detail with reference to the accompanying drawings.

### FIRST EMBODIMENT

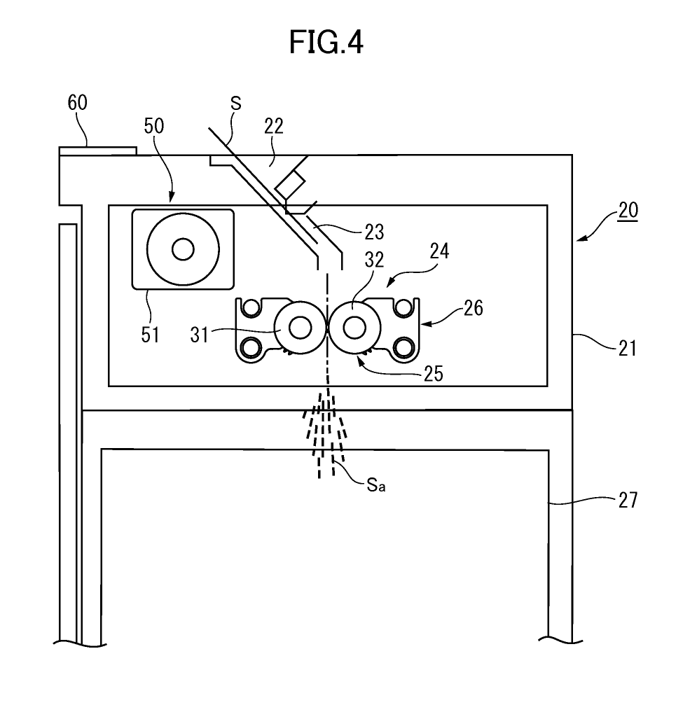

FIG. 4 illustrates an overall configuration of a shredder according to a first embodiment of the present invention.

Overall Configuration of Shredder

As illustrated in FIG. 4, a shredder 20 includes a shredder casing 21 having a substantially rectangular parallelepiped shape. A feed port 22 through which sheets S as sheet-like objects to be shredded are fed is opened in an upper surface of the shredder casing 21. A conveying path 23 defined by a pair of guide chutes is provided in the feed port 22. A shredding unit 24 is arranged in a midway of the conveying path 23. Below the shredding unit 24 in the shredder casing 21, a trash container 27 for receiving particles Sa of the sheets S is arranged so as to be removable.

Here, the shredding unit 24 includes a shredding mechanism 25 to shred sheets S and a cleaning mechanism 26 to clean the shredding mechanism 25.

Specifically, as illustrated in FIG. 4, the shredding mechanism 25 employs a cross-cut type using blade drums 31 and 32 in a pair as cutter elements. With this, when the sheets S are inserted through a meshing region between the blade drums 31 and 32 in a pair, the sheets S are shredded simultaneously in a direction along a conveying direction of the sheets S (longitudinal direction) and a crossing direction substantially orthogonal thereto (lateral direction). Note that, in FIG. 4, a drive device for driving the shredding mechanism 24 is denoted by the reference symbol 50, and an operation panel for operating the shredder 20 is denoted by the reference symbol 60.

Drive Device

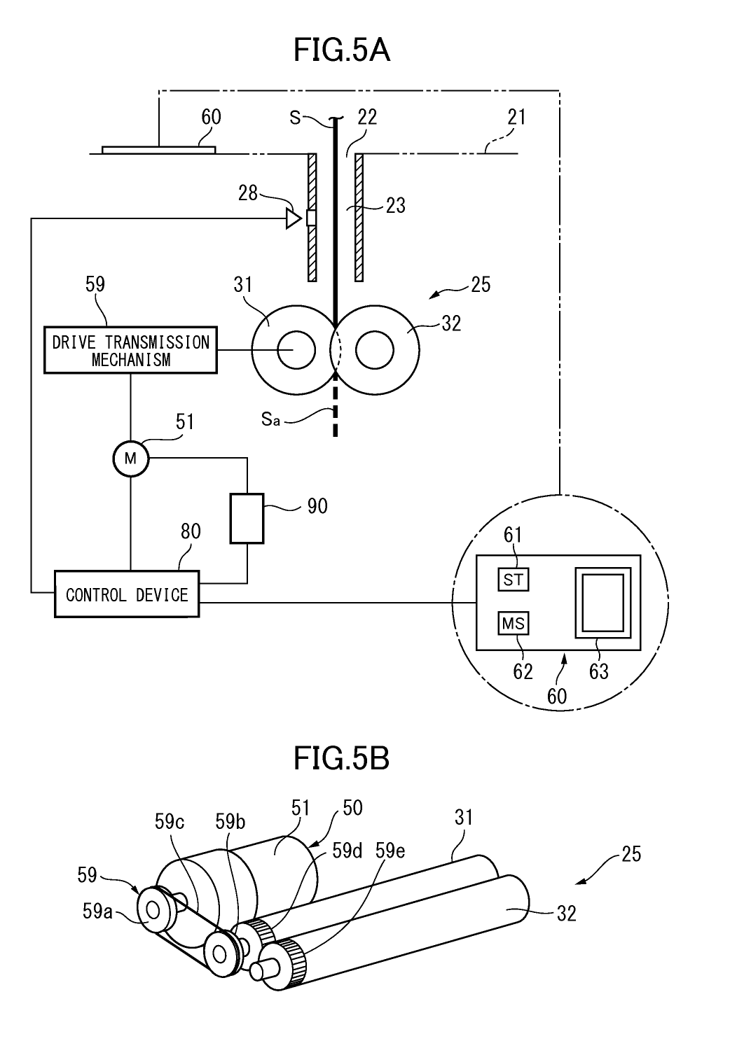

In this embodiment, as illustrated in FIG. 4 and FIGS. 5A and 5B, the drive device 50 includes a drive motor 51 as a drive source, and a drive transmission mechanism 59 for transmitting a driving force from the drive motor 51 to the blade drums 31 and 32 in a pair of the shredding mechanism 25.

In this embodiment, the drive transmission mechanism 59 includes pulleys 59a and 59b fixed respectively to a drive shaft of the drive motor 51 and the rotary shaft of the first blade drum 31, and a transmission belt 59c looped around the pulleys 59a and 59b. Further, transmission gears 59d and 59e are engaged with each other and fixed to the rotary shafts of the blade drums 31 and 32 in a pair.

Control Device

Further, in this embodiment, as illustrated in FIG. 5, the drive device 50 for driving the shredding mechanism 25 is controlled by a control device 80.

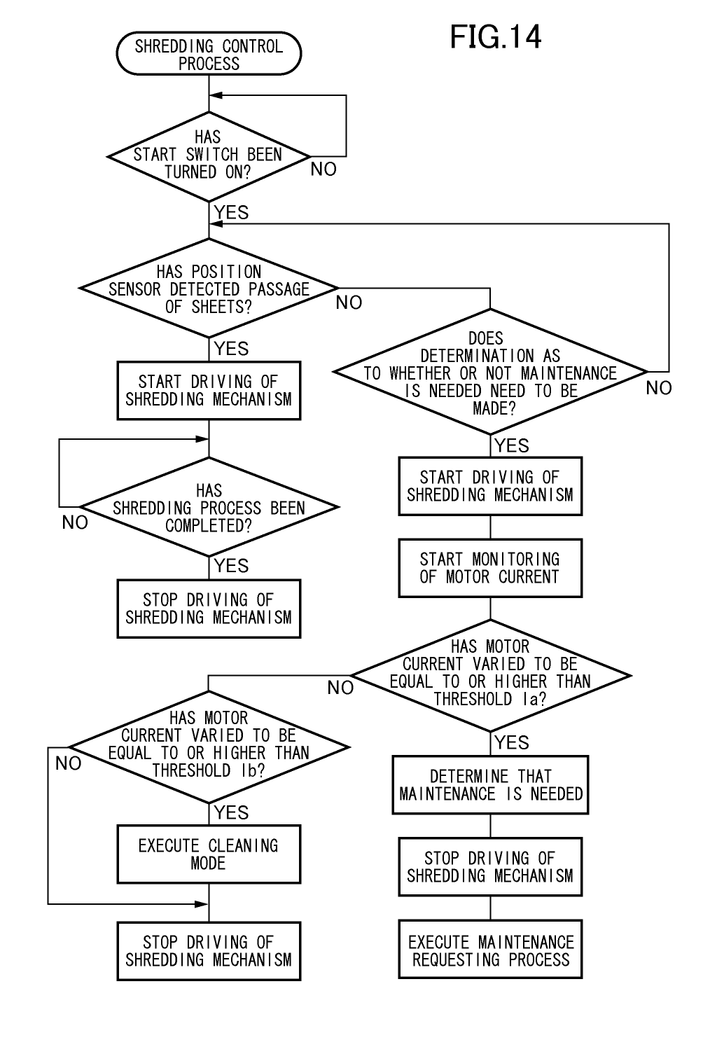

In this embodiment, the control device 80 has a microcomputer system including a CPU, a RAM, a ROM, and input/output ports. The control device 80 receives, for example, operation signals from the operation panel 60, and signals from a position sensor 28 for detecting whether or not sheets S are conveyed in the conveying path 23 via the input/output ports. The control device 80 causes the CPU and the RAM to execute a shredding control program (refer to FIG. 14) preinstalled in the ROM, to thereby transmit predetermined control signals to the drive device 50 for the shredding mechanism 25 via the input/output ports.

In addition, a current detector 90 is provided for the drive motor 51 so as to detect drive current supplied to the drive motor 51.

Note that, in this embodiment, as illustrated in FIG. 5, the operation panel 60 includes a start switch 61 (abbreviated as “ST” in FIG. 5) for turning on the shredder 20, a mode selection switch (abbreviated as “MS” in FIG. 5) for performing ON operations to specify, for example, a discharge mode for reversely discharging the sheets S in a case where the sheets S jam in the conveying path 23, and a cleaning mode for executing a cleaning process in a case where the particles Sa jam in the shredding mechanism 25, and a display 63 for displaying operating conditions of the shredder 20. Further, as the position sensor 28, sensors of a mechanical type, an optical type, and other types may be selected as appropriate as long as passage of the sheets S can be detected.

Shredding Mechanism

In this embodiment, as described earlier, the shredding mechanism 25 includes the blade drums 31 and 32 in a pair.

Now, as illustrated in FIGS. 4, 6 and 7, the first blade drum 31 includes a drum body 311 made of a high strength material such as carbon steel, and the drum body 311 is supported by a support frame (not shown) in a rotatable manner about a rotary shaft 310.

In addition, on a peripheral surface of the drum body 311, cutter portions 312 each including cutting blades 313 formed at a predetermined pitch p (for example, 3.5 mm) in a rotation direction of the drum body 311 are integrally formed by a cutting-out process through intermediation of recessed portions 315 at a predetermined clearance g (for example, 0.7 mm) along a direction of the rotary shaft 310 of the drum body 311. Note that, a bottom surface of each of the recessed portions 315 between the cutter portions 312 is formed as a spacer portion 314 having a circular section, and a width dimension of a distal edge portion of each of the cutter portions 312 is set to be equivalent to that of the recessed portions 315.

In this embodiment, the cutting blades 313 have distal edge portions as a functional portion for cutting the sheets in a direction intersecting with the conveying direction of the sheets (lateral direction), and lateral edge portions, which are located on both sides of each of the distal edge portions, as another functional portion for cutting the sheets in the direction along the conveying direction of the sheets (longitudinal direction). In addition, in order to keep sufficient cutting performance, the distal edge portions and the lateral edge portions of the cutting blades 313 are subjected to a polishing process.

Further, as illustrated in FIGS. 4, 6 and 7, the second blade drum 32 is constructed substantially similarly to the first blade drum 31 with a high strength material such as carbon steel. On a peripheral surface of a drum body 321, cutter portions 322 each including cutting blades 323 are integrally formed by the cutting-out process through intermediation of recessed portions 325. Note that, a rotary shaft of the drum body 321 is denoted by the reference symbol 320, and a circular-section spacer portion formed of a bottom surface of each of the recessed portions 325 between the cutter portions 322 is denoted by the reference symbol 324.

Still further, the second blade drum 32 meshes with the first blade drum 31 in a manner that the cutter portions 322 bite into the recessed portions 315 of the first blade drum 31, and that the cutter portions 312 of the first blade drum 31 bite into the recessed portions 325.

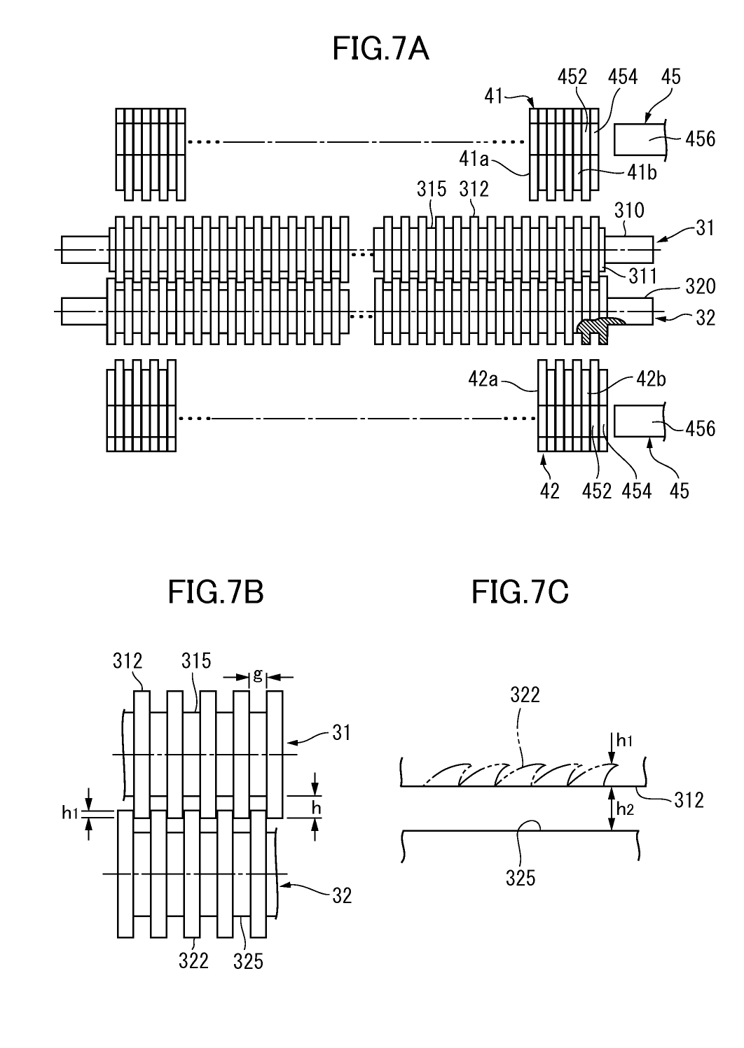

Yet further, in a meshing region M between the blade drums 31 and 32 in a pair, as illustrated in FIGS. 7A to 7C, when the recessed portions 315 (or 325) have a depth “h”, the cutting blades 323 (or 313) of the cutter portions 322 (or 312) bite into the recessed portions 315 (or 325) with a dimension h1 by which the cutting blades 323 (or 313) are received in the recessed portions 315 (or 325). Note that, in FIG. 7C, a dimension obtained by subtracting the bite-in dimension h1 of the cutting blades 323 (or 313) from the depth h of the recessed portions 315 (or 325) is denoted by the reference symbol h2.

Cleaning Mechanism

<Base Configuration of Scrapers>

In this embodiment, the cleaning mechanism 26 is provided in a region out of the meshing region M between the blade drums 31 and 32 in a pair, and includes scrapers 41 and 42 as scraping members to scrape particles Sa attached around the blade drums 31 and 32 in pair. Those scrapers 41 and 42 are each formed of a plate member made of a high strength material such as carbon steel.

In this embodiment, the scrapers 41 include first partition members 41a provided so as to surround substantially left half of the first blade drum 31, that is, surround an opposite side of the meshing region M between the blade drums 31 and 32 in a pair, and provided correspondingly to the recessed portions 315 between the cutter portions 312 of the first blade drum 31, and second partition members 41b arranged between the first partition members 41a correspondingly to the cutter portions 312 of the first blade drum 31.

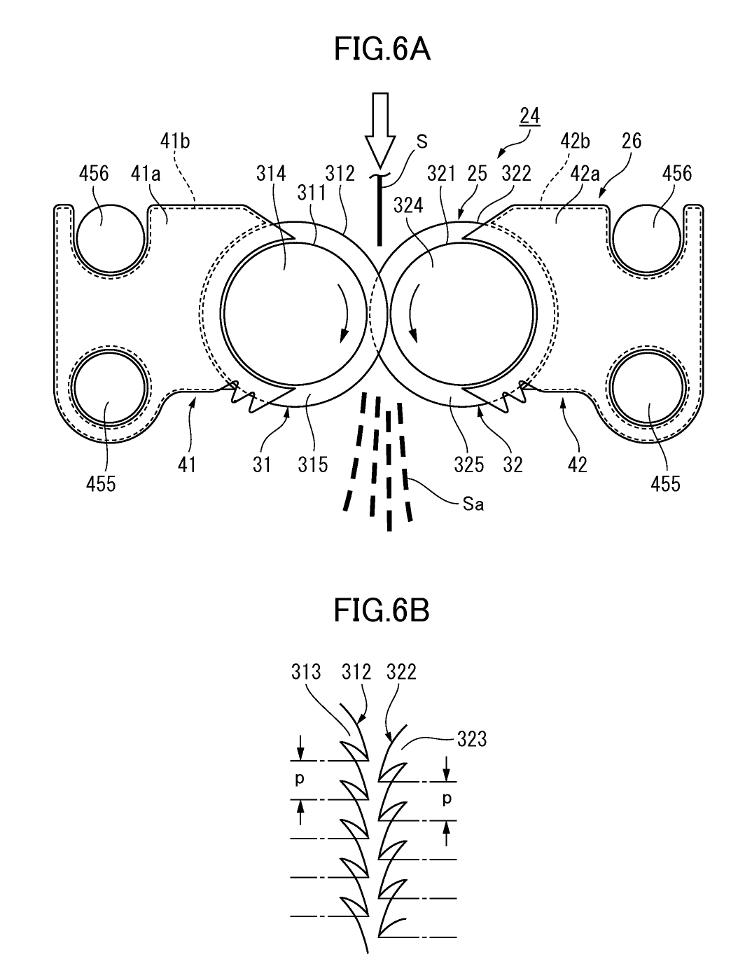

Note that, as illustrated in FIGS. 6 and 7, the first partition members 41a are arranged so as to bite into the recessed portions 315 between the cutter portions 312 of the first blade drum 31. With this, among the particles Sa formed by shredding in the meshing region M between the blade drums 31 and 32 in a pair, particles Sa accumulated in the recessed portions 315 are scraped off.

Further, as illustrated in FIGS. 6 and 7, the second partition members 41b are arranged so as to surround the cutter portions 312 of the first blade drum 31. With this, among the particles Sa formed by shredding in the meshing region M between the blade drums 31 and 32 in a pair, particles Sa adhering to peripheries of the cutter portions 312 are scraped off.

On the other hand, the scrapers 42 include first partition members 42a provided so as to surround substantially right half of the second blade drum 32, that is, surround an opposite side of the meshing region M between the blade drums 31 and 32 in a pair, and provided correspondingly to the recessed portions 325 between the cutter portions 322 of the second blade drum 32, and second partition members 42b arranged between the first partition members 42a correspondingly to the cutter portions 322 of the second blade drum 32.

Note that, as illustrated in FIGS. 6 and 7, the first partition members 42a are arranged so as to bite into the recessed portions 325 between the cutter portions 322 of the second blade drum 32. With this, among the particles Sa formed by shredding in the meshing region M between the blade drums 31 and 32 in a pair, particles Sa accumulated in the recessed portions 325 are scraped off.

Further, as illustrated in FIGS. 6 and 7, the second partition members 42b are arranged so as to surround the cutter portions 322 of the second blade drum 32. With this, among the particles Sa formed by shredding in the meshing region M between the blade drums 31 and 32 in a pair, particles Sa adhering to peripheries of the cutter portions 322 are scraped off.

<Configuration Example of First Partition Members>

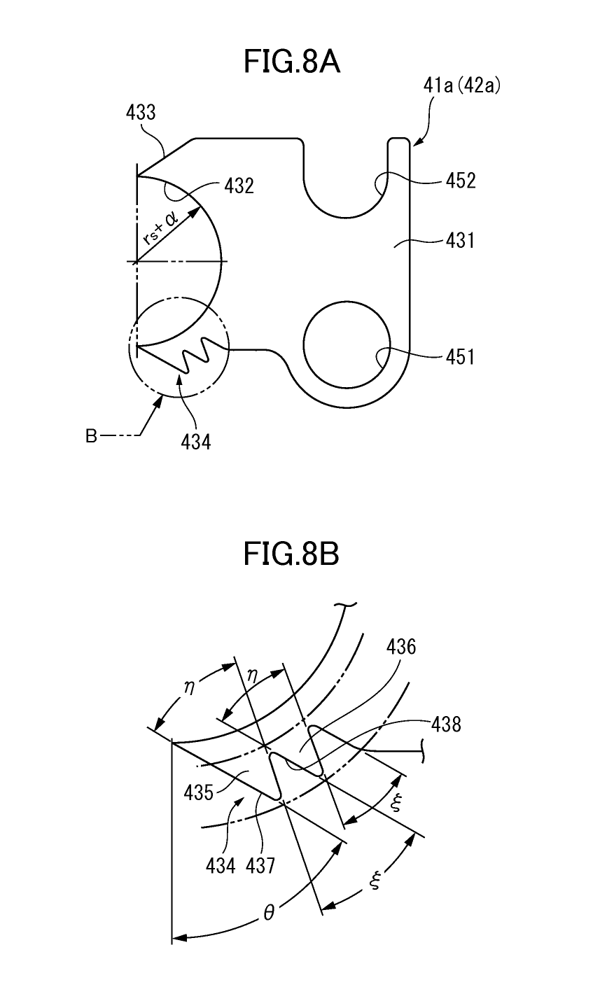

As illustrated in FIG. 6 and FIGS. 8A and 8B, the first partition members 41a (or 42a) each include a plate-like partition body 431, and have a circular-arc edge surface (in this example, semicircular edge surface) 432 conforming to a shape of a bottom surface of, the recessed portion 315 (or 325) of the blade drum 31 (or 32) at a part of the partition body 431 facing the recessed portion 315 (or 325). Further, a guide surface 433 for guiding the sheets S into the meshing region M between the blade drums 31 and 32 in a pair is formed on one side of the partition body 431, in which the sheets S are conveyed. In addition, a guide piece 434 for guiding downward the particles Sa formed by shredding in the meshing region M between the blade drums 31 and 32 in a pair is formed on another side of the partition body 431, on which the sheets S are discharged.

In this embodiment, as illustrated in FIGS. 8A and 10A, the edge surface 432 of the first partition member 41a (or 42a) is formed into a circular-arc surface having a radius of rs+α, which is slightly larger than a radius rs of the spacer portion 314 (or 324) located between the cutter portions 312 (or 322) of the blade drum 31 (or 32).

Further, in this embodiment, as illustrated in FIGS. 8A and 8B, the guide piece 434 includes two mountain-shaped guide projections 435 and 436 extending obliquely downward. The guide projection 435 located on a side of a path of the sheets S is formed, for example, to have an inclined surface 437 inclined at a predetermined angle θ (for example, 30° to 50°) with respect to a vertical direction, and to have a distal end corner portion projecting at an angle η (for example, 20° to 40°: η<θ in this example). Further, the another guide projection 436 is formed, for example, to be adjacent to the guide projection 435 through intermediation of a V-groove 438 having a distal end angle ξ (for example, 20° to 40°, η=ξ in this example), and to project at a distal end angle η.

<Configuration Example of Second Partition Members>

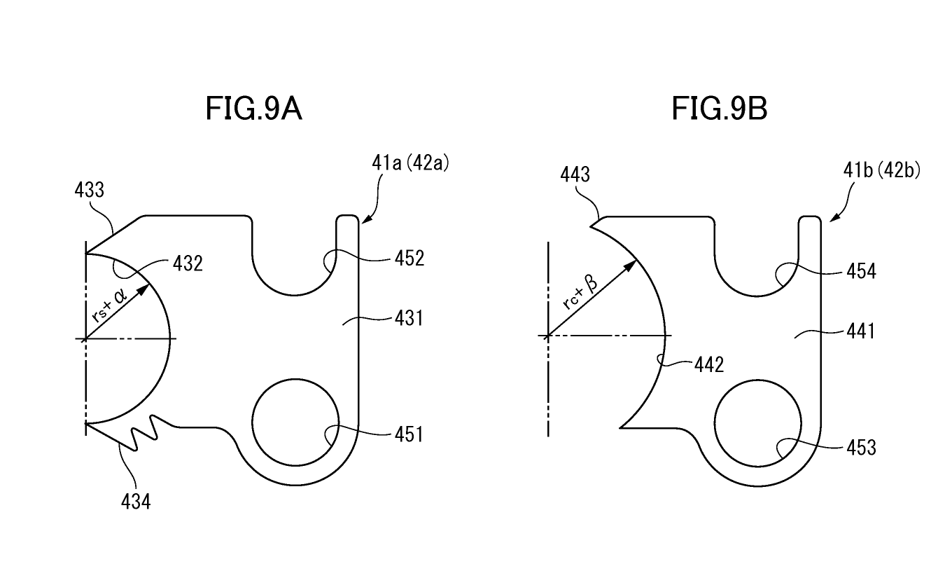

As illustrated in FIG. 6 and FIGS. 9A and 9B, the second partition members 41b (or 42b) each include a plate-like partition body 441, and have a circular-arc edge surface (in this example, an angle of the circular arc is less than that of a semicircular, an edge surface of 140° to 150°, for example) 442 conforming to distal end outer rims of the cutter portions 312 (or 322) of the blade drum 31 (or 32) at a part of the partition body 441.

In this embodiment, as illustrated in FIGS. 9B and 10B, the edge surface 442 of the second partition member 41b (or 42b) is formed into a circular-arc surface having a radius of rc+β, which is slightly larger than a radius rc of the distal end outer rims of the cutter portions 312 (or 322) of the blade drum 31 (or 32).

Then, in this embodiment, the second partition members 41b (or 42b) are each formed so as to have a guide surface 443 following the guide surfaces 433 of the first partition members 41a (or 42a) at the time when the second partition members 41b (or 42b) are overlapped with the first partition members 41a (or 42a), and to have an upper side portion, a lower side portion, and a lateral side portion that is located on an opposite side of the edge surface 432, which substantially match with those of the partition body 431 of the first partition members 41a (or 42a).

<Positioning Mechanism>

In this embodiment, as illustrated in FIGS. 6 to 10, the cleaning mechanism 26 includes a positioning mechanism 45 capable of positioning the first partition members 41a (or 42a) and the second partition members 41b (or 42b) of the scrapers 41 (or 42).

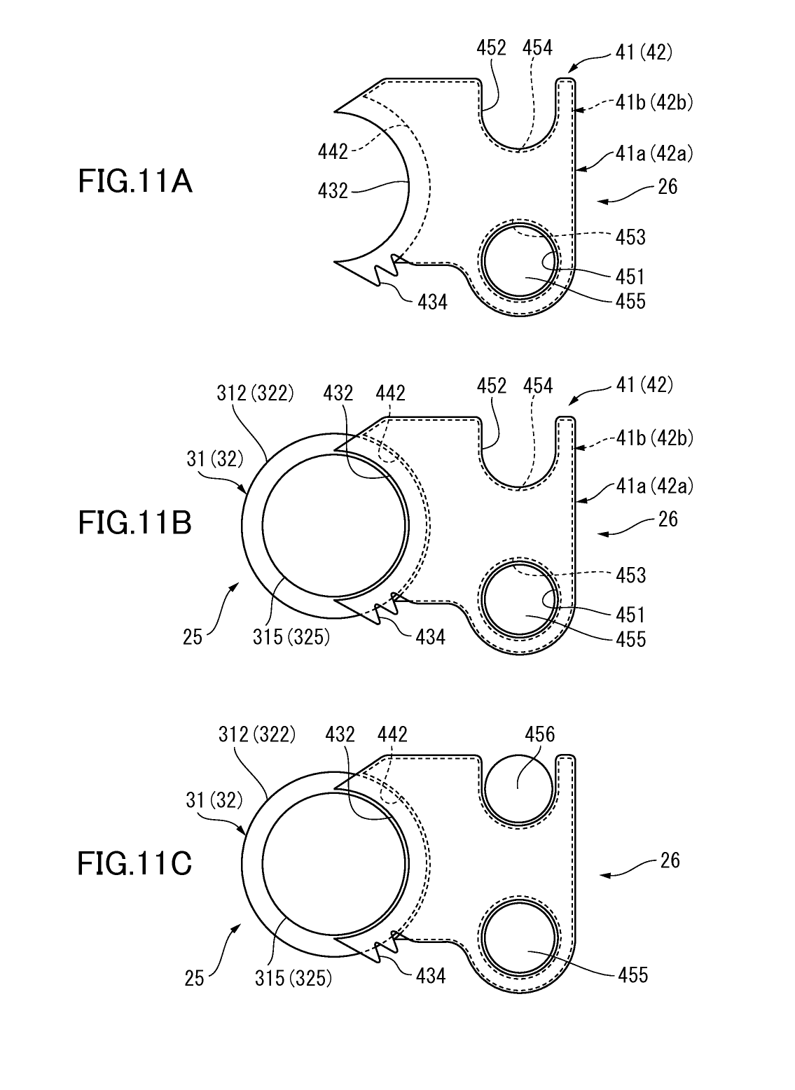

In this embodiment, in the positioning mechanism 45, a circular positioning hole 451 is opened at an arbitrary position (in this embodiment, a lower corner portion on a side away from the blade drum 31 (or 32)) in the partition body 431 of each of the first partition members 41a (or 42a). A U-shaped positioning groove 452 is formed at a part away from the positioning hole 451 (in this embodiment, the upper side portion of the partition body 431, which is located right above the positioning hole 451). In addition, in the partition body 441 of each of the second partition members 41b (or 42b), a positioning hole 453 and a positioning groove 454 are formed as counterparts at positions corresponding to the positioning hole 451 and the positioning groove 452 of the first partition members 41a (or 42a). Under a state in which the first partition members 41a (or 42a) and the second partition members 41b (or 42b) are stacked alternately to each other, a first positioning rod 455 (refer to FIG. 11) is inserted through the positioning holes 451 and 453, and a second positioning rod 456 is inserted through the positioning grooves 452 and 454. With this, the first partition members 41a (or 42a) and the second partition members 41b (or 42b) of the scrapers 41 (or 42) are positioned.

Assembly Process of Shredding Unit

Description is made of an assembly process of the shredding unit 24 in this embodiment.

In order to assemble the shredding unit 24, the cleaning mechanism 26 needs to be assembled to the blade drums 31 and 32 in a pair as the shredding mechanism 25.

First, as illustrated in FIG. 11A, as the scrapers 41 (or 42) which are the cleaning mechanism 26, the first partition members 41a (or 42a) and the second partition members 41b (or 42b) are stacked alternately to each other, and then the first positioning rod 455 is inserted through the positioning holes 451 and 453.

In this state, the first partition members 41a (or 42a) and the second partition members 41b (or 42b) are freely pivotable about a position of the first positioning rod 455.

Then, as illustrated in FIG. 11B, around the blade drum 31 (or 32), the first partition members 41a (or 42a) and the second partition members 41b (or 42b) of the scrapers 41 (or 42) are arranged respectively at parts corresponding to the recessed portions 315 (or 325) of the blade drum 31 (or 32) and parts corresponding to the cutter portions 312 (or 322) of the blade drum 31 (or 32).

Next, at a stage when the arrangement of the partition members 41a and 41b (or 42a and 42b) of the scrapers 41 (or 42) as the cleaning mechanism 26 is completed, as illustrated in FIG. 11C, the second positioning rod 456 is inserted through the positioning grooves 452 and 454 of the first partition members 41a (or 42a) and the second partition members 41b (or 42b).

In this state, when the positioning rods 455 and 456 are positioned to predetermined positions in the shredder casing 21, the scrapers 41 and 42 are positioned with respect to the blade drums 31 and 32 with reference to the positions of the positioning rods 455 and 456. In this way, the shredding unit 24 is installed at a predetermined position in the shredder casing 21.

Shredding Control Process of Shredder

Next, description is made of a shredding control process of the shredder according to this embodiment mainly with reference to FIG. 5 and the flowchart shown in FIG. 14.

<Normal Shredding Process>

First, when the control device 80 determines that the ON operation has been input via the start switch 61 of the operation panel 60, the control device 80 specifies a predetermined one of driving conditions of the drive device 50 (such as a driving speed condition of the drive motor 51).

In this state, the sheets S, which are fed into the feed port 22 of the shredder casing 21, are moved to the shredding mechanism 25 along the conveying path 23. At this time, when the position sensor 28 detects the passage of the sheets S, the signal detected by the position sensor 28 is transmitted to the control device 80. In response thereto, the drive motor 51 drives the blade drums 31 and 32 in a pair in the shredding mechanism 25 in accordance with the predetermined one of the driving conditions.

In this embodiment, the sheets S are shredded simultaneously in the longitudinal and lateral directions by passing through the meshing region M between the blade drums 31 and 32 in a pair. The particles Sa formed through the shredding are scraped off from the blade drums 31 and 32 by the scrapers 41 and 42, and fall downward.

In such a shredding process, the particles Sa are formed by shredding into an extremely small size of 0.7 mm×3.5 mm (2.45 mm²), for example. Thus, even when attempts are made to reproduce information of the original sheet by collecting the particles Sa after the shredding process, the reproduction is nearly impossible because the shredding size of the particles Sa is small.

Then, when a predetermined time period elapses after a trailing end of the sheets S passes by the position sensor 28 (time period in which completion of the shredding process is presumed), the control device 80 determines the shredding process has been completed, and stops driving of the drive motor 51. With this, a series of the shredding control process is completed.

<Cleaning Process by the Cleaning Mechanism>

In a normal shredding process, many of the particles Sa formed by shredding in the meshing region M between the blade drums 31 and 32 in a pair fall downward to be received in the trash container 27.

However, a part of the particles Sa may electrostatically adhere to peripheries of the blade drums 31 and 32.

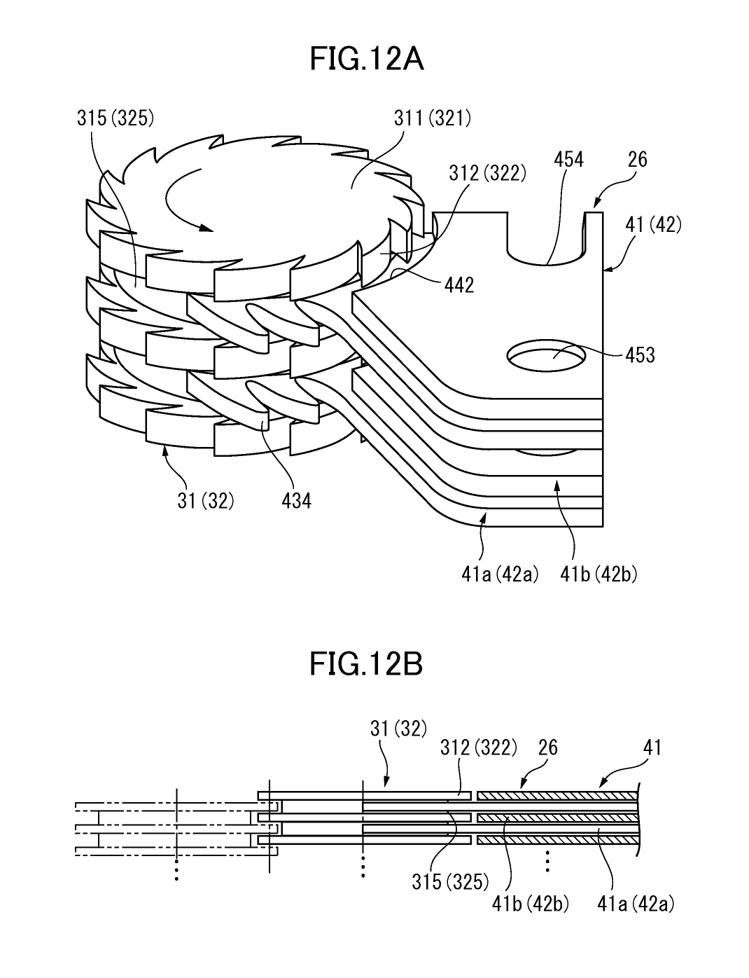

As a countermeasure, as illustrated in FIGS. 6, 12A and 12B, the scrapers 41 (or 42) in this embodiment include not only the first partition members 41a (or 42a) but also the second partition members 41b (or 42b). Thus, not only the particles Sa in the recessed portions 315 (or 325) between the cutter portions 312 (or 322) of the blade drums 31 and 32, but also the particles Sa adhering to the cutter portions 312 (or 322) are scraped off.

Thus, a risk in that the particles Sa are accumulated while electrostatically adhering to the peripheries of the blade drums 31 and 32 is significantly low.

In particular, in this embodiment, the first partition members 41a and the second partition members 41b (or 42a and 42b) respectively form, over a wide range, the edge surfaces 432 and 442 that are close respectively to the bottom surfaces of the recessed portions 315 (or 325) and the distal end outer rims of the cutter portions 312 (or 322) of the blade drum 31 (or 32). Thus, the particles Sa electrostatically adhering to peripheral surfaces of the blade drums 31 and 32 do not pass through minute gaps between the blade drums 31 and 32 and the partition members 41a and 42a (or 41b and 42b).

Further, in this embodiment, the first partition members 41a (or 42a) each include the guide piece 434 as illustrated in FIGS. 8A and 8B. Thus, the particles Sa electrostatically adhering to the peripheral surfaces of the blade drums 31 and 32 strike against the guide piece 434, and then are guided downward. In particular, the guide piece 434 includes the two guide projections 435 and 436, and the V-groove 438 is formed between the guide projections 435 and 436. Thus, even when the particles Sa electrostatically adhere near the guide piece 434, the particles Sa fall near the V-groove 438. In this way, a risk in that the particles Sa are left as they are near the guide piece 434 is significantly low.

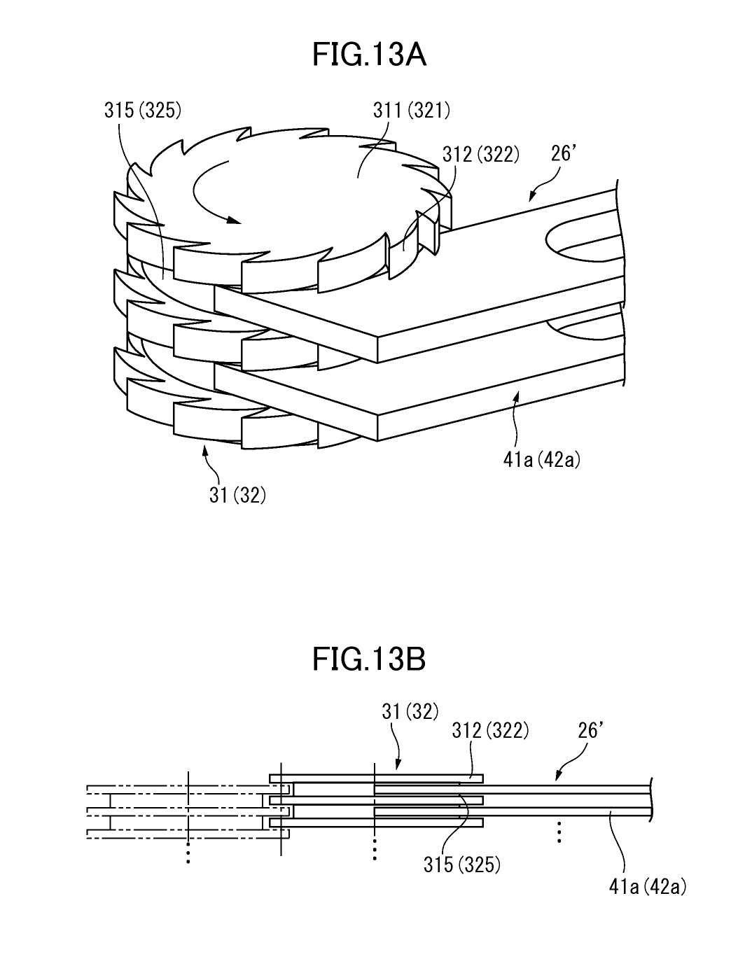

In this respect, when a cleaning mechanism 26′ according to Comparative Example 1 (example in which only the first partition member 41a (or 42a) is provided) is used in place of the cleaning mechanism 26 according to the first embodiment as illustrated in FIGS. 13A and 13B, and when the particles Sa become finer, the particles Sa electrostatically adhering to the cutter portions 312 (or 322) the blade drum 31 (or 32) are liable to remain. In extreme cases, the particles Sa may be accumulated between the first partition members 41a (or 42a), thereby causing a risk of trouble with a rotational operation of the blade drums 31 or 32.

<Maintenance Determination Process>

In this embodiment, as described above, the shredding unit 24 includes the cleaning mechanism 26, so there is little concern that the particles Sa are accumulated around the blade drums 31 and 32. However the shredding size of the particles Sa is extremely small, and hence if the particles Sa maybe accumulated around the blade drums 31 and 32 in a pair, this embodiment includes means to improve this.

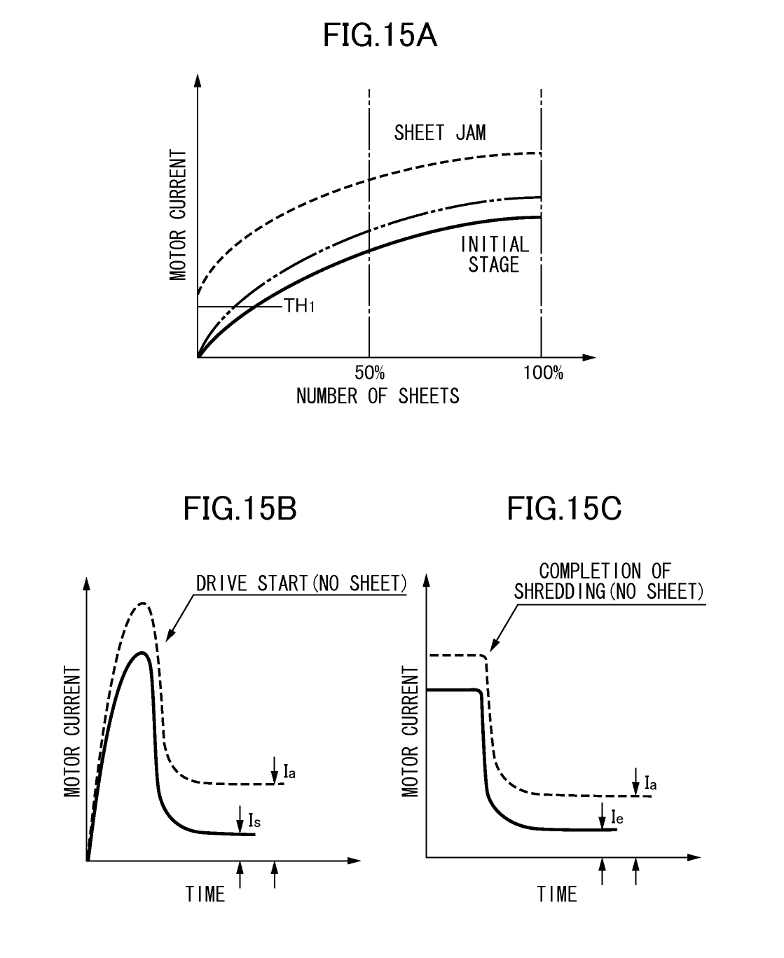

Specifically, as shown in FIG. 15A, in an initial stage of start of use of the shredder, the drive current of the drive motor 51, which is substantially zero under a state in which there are no sheets S to be fed into the feed port 22 of the shredder casing 21, varies to gradually increase in accordance with an increase in the number of the sheets S (number of the sheets S to be simultaneously conveyed into the feed port 22).

On the other hand, as a result of use of the shredder over time, for example, in a case where the particles Sa accumulated around the blade drums 31 and 32 in a pair cause a sheet jam, even when there are no sheets S to be fed into the feed port 22 of the shredder casing 21, the drive current of the drive motor 51 reaches a predetermined level higher than a preset threshold TH₁, and varies to further increase in accordance with an increase in the number of the sheets S. This is presumably because a load is applied to the drive motor 51 due to a jam of the particles Sa around the blade drums 31 and 32 in a pair.

In such a situation, when the drive motor 51 is driven under a state in which an excessive load is applied to the drive motor 51, the shredding mechanism 25 may be damaged.

As a countermeasure, in this embodiment, as shown in FIG. 14, whether or not maintenance of the shredder is needed is determined at preset timings (timing of actuation of the shredder, timing of completion of shredding by the shredder, or timing that is manually specified via the mode selection switch 62) under a condition in which no sheets S are fed in the feed port 22 of the shredder casing 21.

In order to determine whether or not the maintenance is needed, first, the drive motor 51 starts to be driven so that monitoring of the drive current of the motor is started. At this time, whether or not the current of the drive motor 51 has varied to be equal to or higher than a preset threshold level Ia is determined. In this embodiment, this threshold level Ia is set to a level at which the load applied to the drive motor 51 due to an excessive jam of the particles Sa in the shredding mechanism 25 is so high that the maintenance is needed.

In this state, for example, at the timing of actuation of the shredder, as shown in FIG. 15B, the drive current of the drive motor 51 varies to reach a peak once immediately after the actuation, and then decrease to be maintained at a stable level. However, in a case where the drive current in the stable range exceeds an allowable level Is and reaches the threshold level Ia or higher, excessive accumulation of the particles Sa in the shredding mechanism 25 is grasped. Alternatively, for example, at the timing of completion of shredding, as shown in FIG. 15C, the drive current of the drive motor 51 varies to decrease after the completion of shredding, and then be maintained at a stable level. However, in a case where the drive current in the stable range exceeds an allowable level Ie and reaches the threshold level Ia or higher, excessive accumulation of the particles Sa in the shredding mechanism 25 is grasped.

In this way, when the drive current of the drive motor 51 reaches the threshold level Ia or higher, the control device 80 determines that the maintenance is needed, and stops driving of the shredding mechanism 25. With this, a maintenance requesting process is executed.

As an example of the maintenance requesting process, a message such as “Maintenance Required” may be displayed on the display 63 so as to prompt a user to request maintenance. Alternatively, in a case where a shredder with a communication function is used, the communication function may be used for notification of the maintenance requesting process to a maintenance engineer.

<Cleaning Mode>

Further, in this embodiment, with regard to determination as to whether or not the maintenance is needed, the amount of the particles Sa accumulated in the shredding mechanism 25 may be small, and the maintenance may not need to be performed. In such a case, when the small amount of the particles Sa is left as it is, the maintenance needs to be performed sooner or later. In this embodiment, a cleaning mode of executing a process of cleaning the particles Sa accumulated in the shredding mechanism 25 is executed.

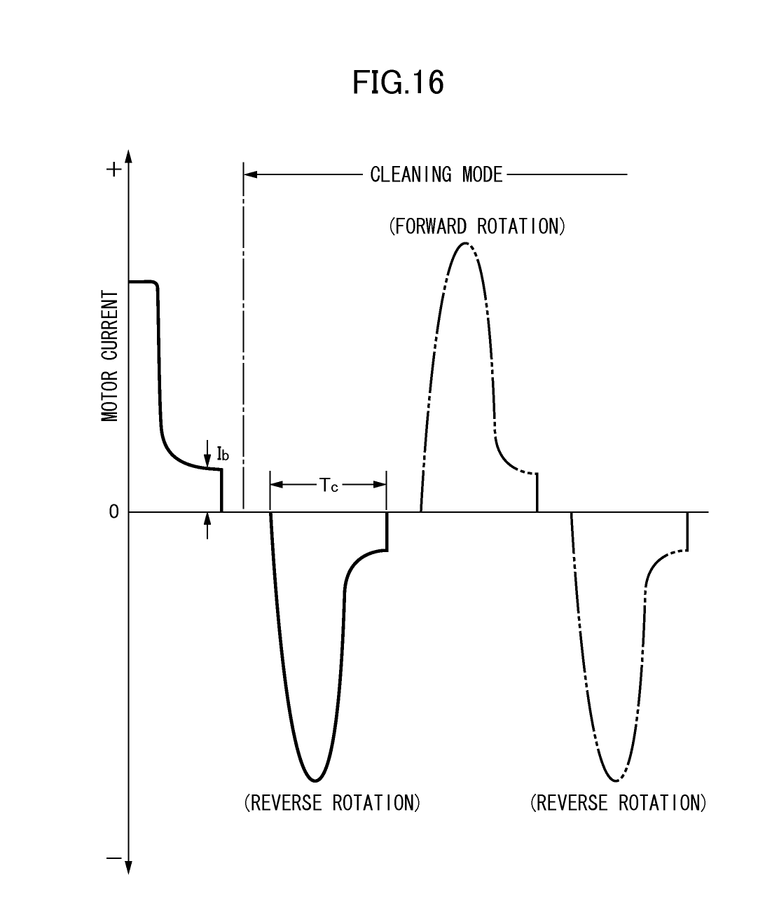

Specifically, as shown in FIG. 16, in a case where the drive current of the drive motor 51, which varies to decrease at the timing of, for example, completion of shredding, and then be maintained at a stable level, reaches thereafter at least a threshold level Ib that is higher than the allowable level Ie (refer to FIG. 15C) and lower than the threshold level Ia, slight accumulation of the particles Sa in the shredding mechanism 25 is grasped.

In this case, the control device 80 executes the cleaning mode. This cleaning mode includes performing reverse rotation of the drive motor 51 after the completion of shredding as shown in FIG. 16, and then, repeating forward rotation and reverse rotation by a predetermined number of times as appropriate as indicated by the imaginary lines in FIG. 16.

In this way, forward/reverse rotations of the drive motor 51 are repeated to perform forward/reverse rotations of the blade drums 31 and 32 in a pair. With this, the particles Sa accumulated around the blade drums 31 and 32 can be effectively scraped off. In this way, the particles Sa accumulated in the shredding mechanism 25 can be cleaned.

Note that, in the cleaning mode of this embodiment, the forward/reverse rotations of the drive motor 51 are repeated several times, however, an effect of the cleaning can be obtained to some extent as long as the reverse rotation of the drive motor 51 is performed at least once.

Modifications

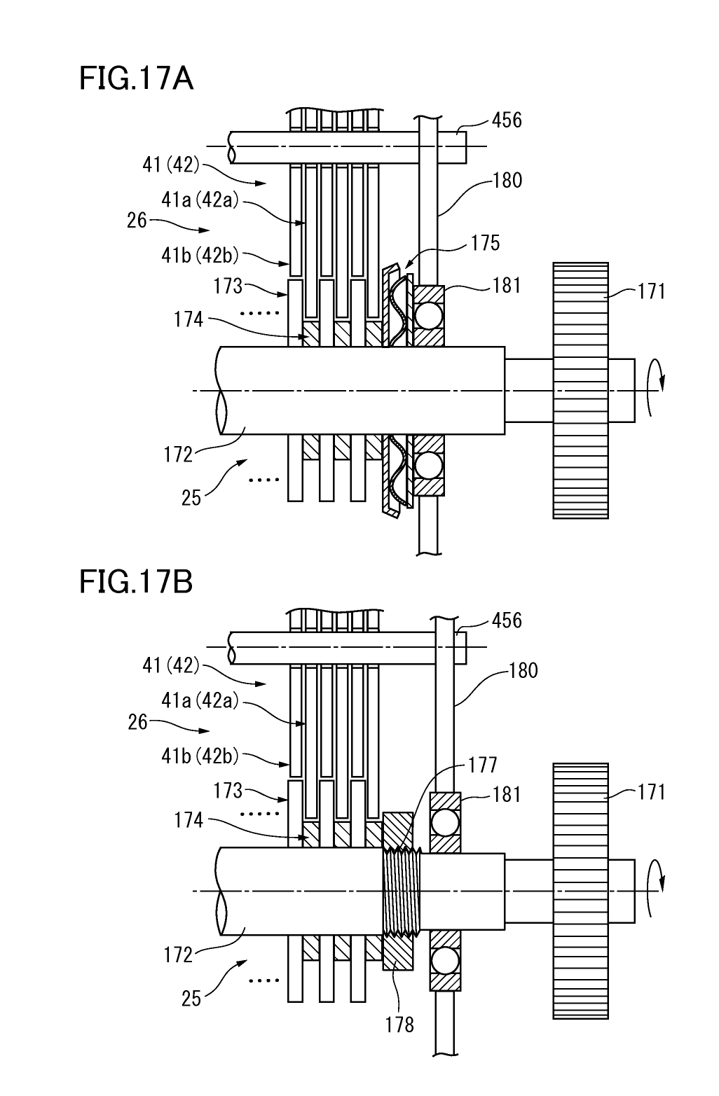

In this embodiment, the blade drums 31 and 32 in a pair are employed in the shredding mechanism 25, but the present invention is not necessarily limited thereto. The scrapers 41 (or 42) of the cleaning mechanism 26 of the first embodiment (including the first partition members 41a (or 42a) and the second partition members 41b (or 42b)) may also be employed in shredding mechanisms 25 of FIGS. 17A and 17B.

The shredding mechanism 25 according to a first modification of the present invention as illustrated in FIG. 17A is constructed such that cutter discs 173 are stacked, through intermediation of spacers 174, along a circular or polygonal rotary shaft 172 to which drive is transmitted from a drive gear 171, and a wave washer 175 is arranged on at least one end portion of the rotary shaft 172 to hold the cutter discs 173 of the shredding mechanism 25 under pressure with a biasing force of the wave washer 175, thereby regulating the positions of the cutter discs 173.

Further, the shredding mechanism 25 according to a second modification of the present invention as illustrated in FIG. 17B is substantially similar to the shredding mechanism 25 according to the first modification, but is different from the shredding mechanism 25 according to the first modification in that a male screw portion 177 is formed on the end portion of the rotary shaft 172 in place of the wave washer 175, and a nut 178 threadedly engaged with the male screw portion 177 is tightened to hold the cutter discs 173 of the shredding mechanism 25 under pressure, thereby regulating the positions of the cutter discs 173.

Note that, in FIGS. 17A and 17B, a support frame 180 is configured to support the shredding unit 24, and a bearing 181 is configured to support the rotary shaft 172 in a rotatable manner.

### SECOND EMBODIMENT

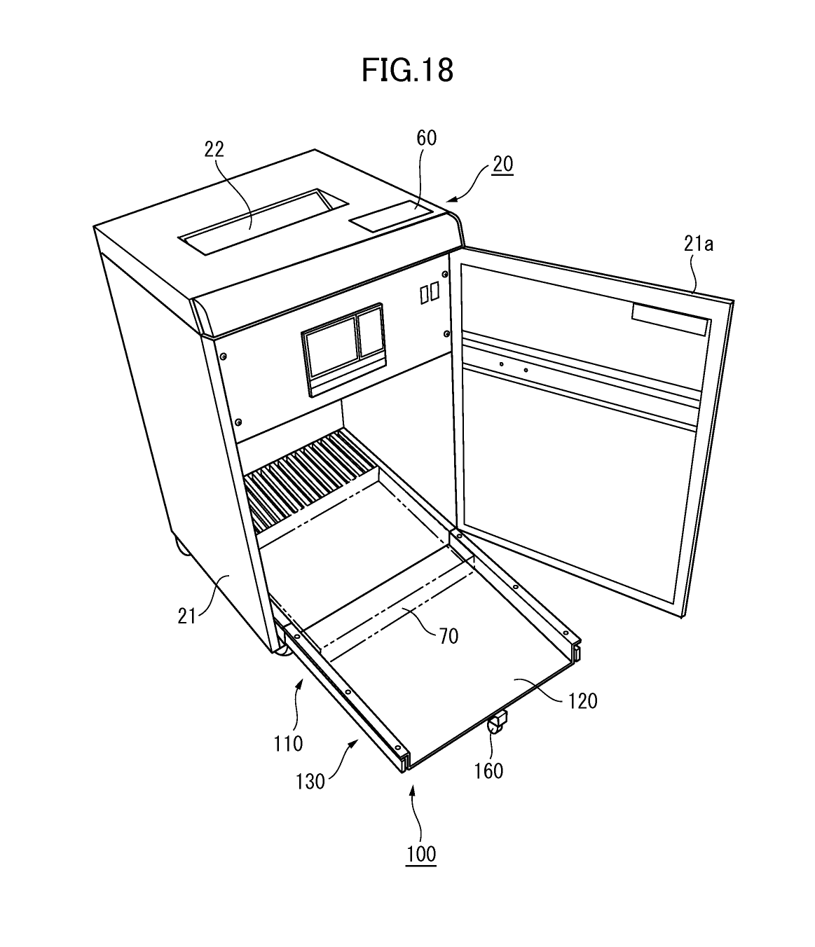

FIG. 18 is an explanatory view of a main part of a shredder according to a second embodiment of the present invention.

In FIG. 18, a basic configuration of the shredder is substantially similar to the configuration according to the first embodiment, but this embodiment is different from the first embodiment in that a trash container drawing mechanism 100 is arranged on a bottom portion of the shredder casing 21.

Trash Container Drawing Mechanism

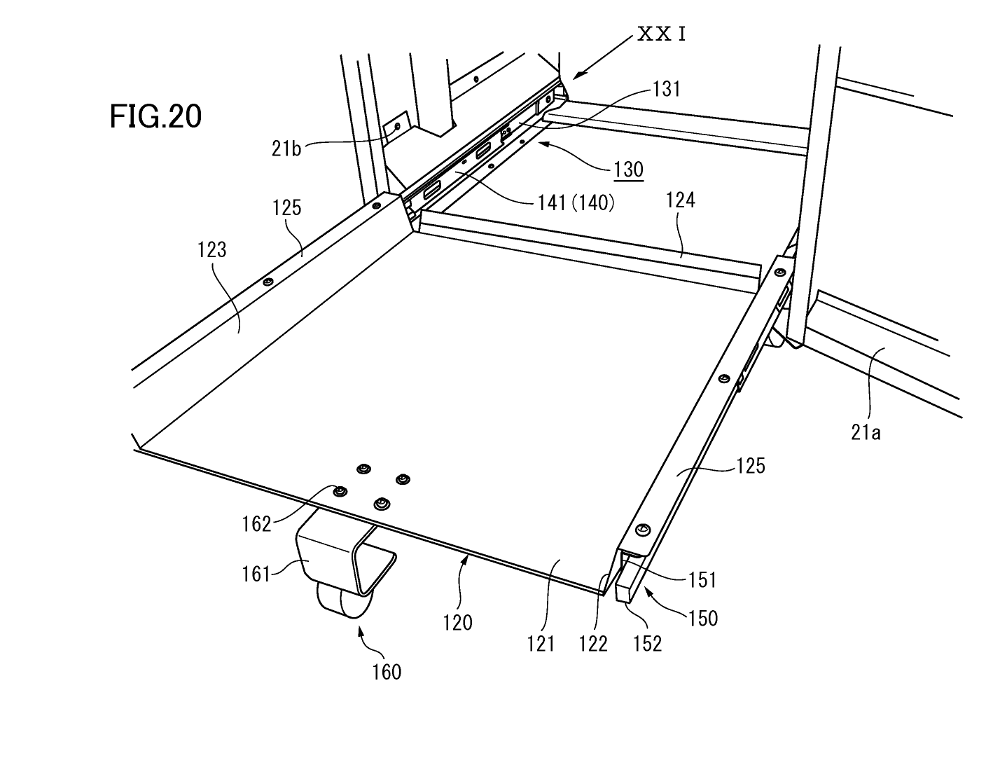

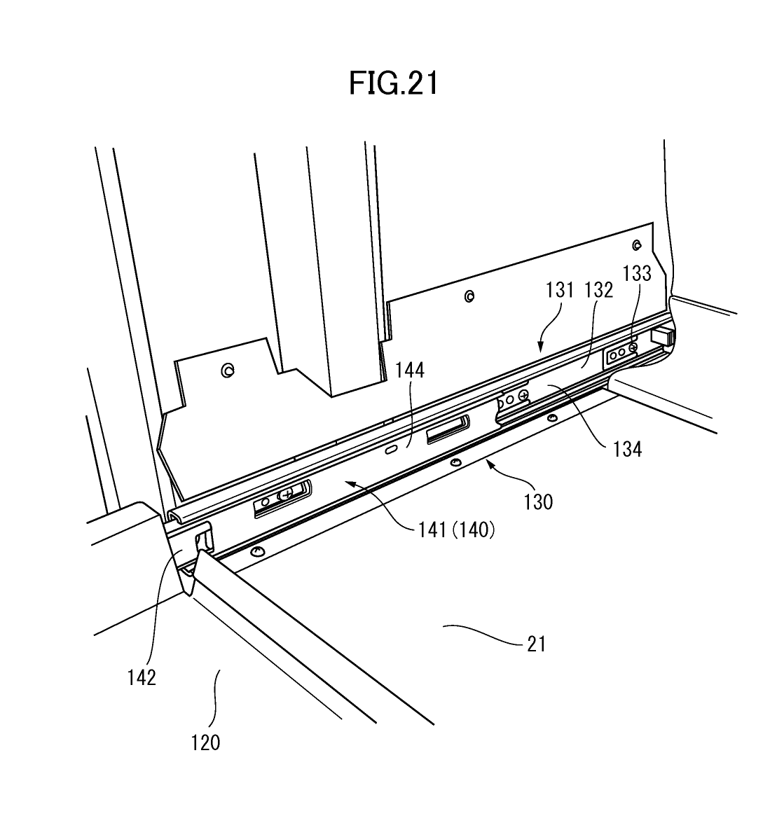

As illustrated in FIGS. 18 to 23, the trash container drawing mechanism 100 includes a tray 70 as a receiving member on which the trash container 27 is mounted, and a guide mechanism 110 for guiding the tray 70 in a drawable manner.

In this embodiment, the guide mechanism 110 includes a mounting base 120 on which the tray 70 is mounted in a separable manner, guide rails 130 for guiding the mounting base 120 along the drawing direction, and a guide roller 160 arranged on a front side in the drawing direction of the mounting base 120, for supporting and guiding the front side in the drawing direction of the mounting base 120 when drawing the mounting base 120 out of the shredder casing 21.

<Mounting Base>

In this embodiment, the mounting base 120 includes a rectangular support plate 121 sized substantially in conformity with a bottom surface of the shredder casing 21, and side walls 122 to 124 are raised at portions except for an edge portion on the front side in the drawing direction of the mounting base 120 among the peripheral edges of the support plate 121. In this case, the side walls 122 and 123 of the support plate 121, which extend in a direction along the drawing direction of the mounting base 120, have flanges 125 each projecting outward substantially into an inverted L-shape in cross-section. Further, the side wall 124 of the support plate 121 on a front side in a pushing direction of the mounting base 120 is arranged in an inclined manner to project outward.

<Guide Rails>

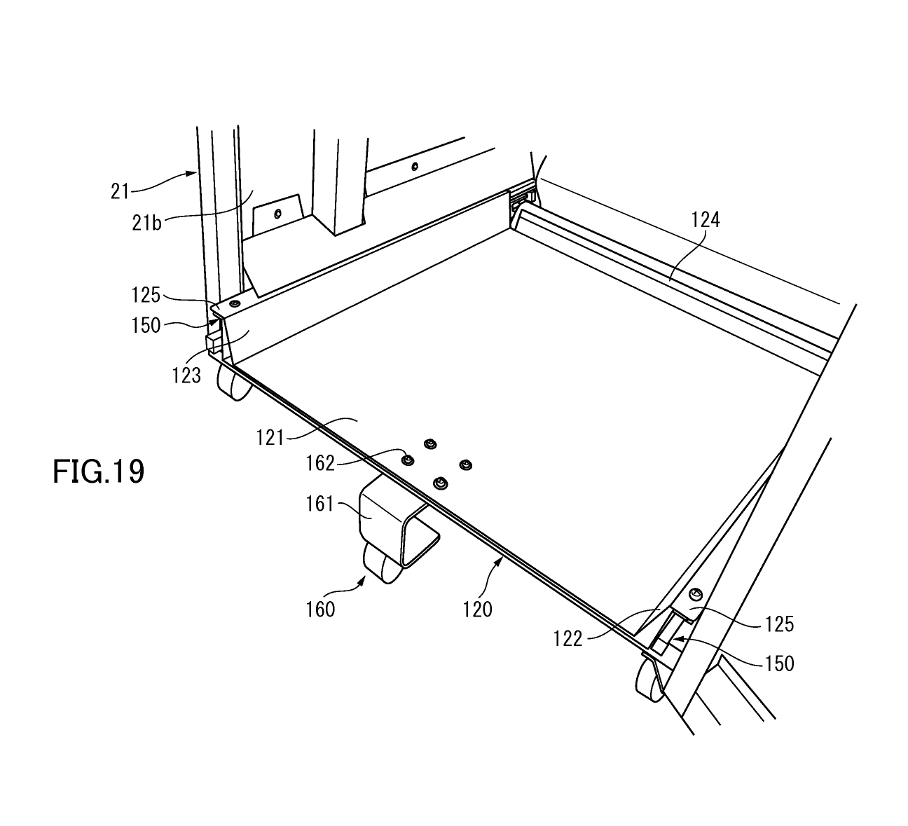

In this embodiment, as illustrated in FIGS. 19 to 22B, the guide rails 130 include fixed guide rails 131 in a pair, which are mounted on both sides of lower portions of side walls 21b of the shredder casing 21 in the direction along the drawing direction of the mounting base 120, and movable guide rails 140 in a pair, which are arranged on both sides along the drawing direction of the mounting base 120.

In this case, as illustrated in, for example, FIGS. 19 to 22B, the fixed guide rails 131 in a pair are constructed in the following manner. Channel members 132 each having a U-shape in cross-section are arranged so that their openings face each other, and are fixed to the lower portions of the side walls 21b of the shredder casing 21 with fasteners 133 such as screws. Further, the movable guide rails 140 are configured to slide along U-shaped guide grooves 134 of the channel members 132. Note that, a space portion 135 having a predetermined clearance is formed below a lower wall of each of the fixed guide rails 131.

Further, each of the movable guide rails 140 includes multi-stage (in this embodiment, three-stage) guide rail elements 141 to 143 configured to slide along the fixed guide rail 131, and to be drawn out of the fixed guide rail 131. In this case, all of the guide rail elements 141 to 143 are formed of channel members each having a substantial U-shape in cross-section. The first guide rail element 141 is configured to slide along the guide groove 134 of the fixed guide rail 131, the second guide rail element 142 is fitted into a U-shaped guide groove (144) of the first guide rail element 141 in a freely slidable manner, and the third guide rail element 143 is fitted into a U-shaped guide groove (not shown) of the second guide rail element 142 in a freely slidable manner. The first to third guide rail elements 141 to 143 are configured to extend in a manner of being sequentially drawn out of the fixed guide rail 131.

Note that, stoppers 146 to 148 are configured to regulate the amounts of drawing the first to third guide rail elements 141 to 143.

Besides, a channel-shaped rail 150 to be guided, which is configured to embrace the fixed guide rail 131 from its outer side, is arranged on an outer side of each of the side walls 122 and 123 of the mounting base 120. The rail 150 to be guided is formed of an L-shaped rail element 151 and a bar-shaped rail element 152. The L-shaped rail element 151 is received to cover an upper wall and opening of the fixed guide rail 131, whereas the bar-shaped rail element 152 is received in the space portion 135 formed below the lower wall of the fixed guide rail 131.

In addition, the third guide rail element 143 of the movable guide rail 140 is fixed to the rail 150 to be guided.

<Guide Roller>

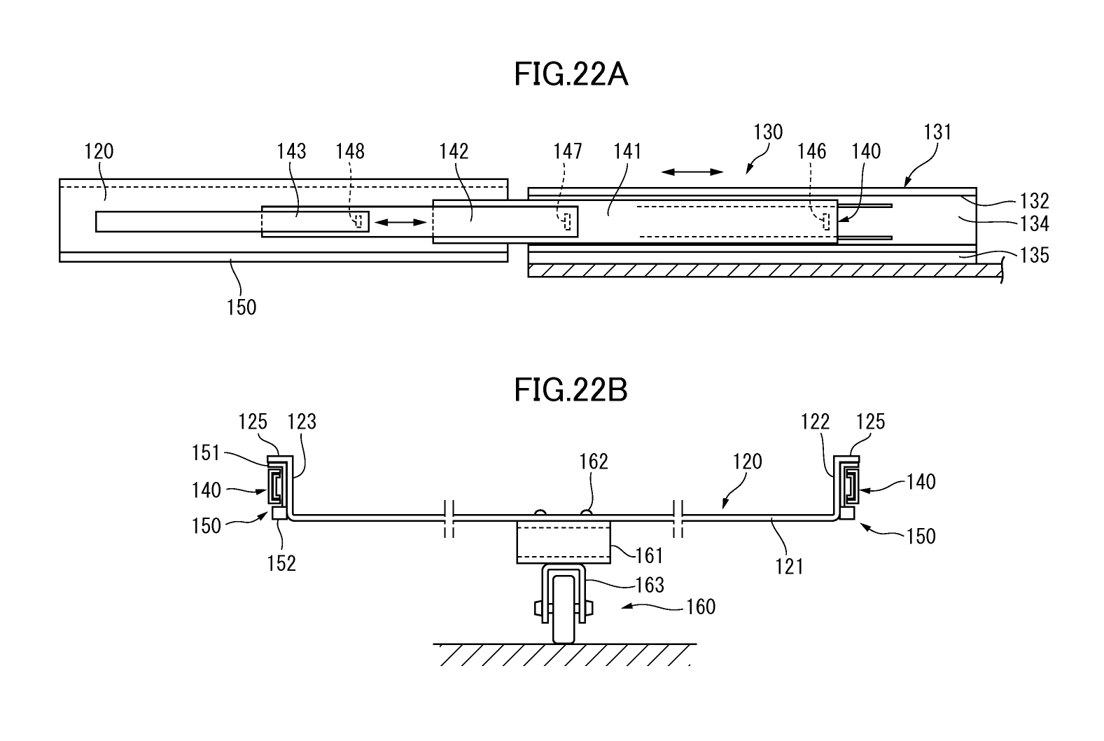

As illustrated in FIG. 18 and FIG. 22B, a support bracket 161 having a J-shape in cross-section is fixed to a vicinity of a center of the front side in the drawing direction of the mounting base 120 with fasteners 162 such as screws, and the guide roller 160 is held in a rotatable manner on a lower portion of the support bracket 161 through intermediation of a holder 163.

Shredding Control Process of Shredder

A shredding control process of the shredder according to this embodiment is substantially similar to the shredding control process of the shredder according to the first embodiment.

Post-process on Shreds

Next, description is made of how the user executes a post-process on the shreds formed of the particles Sa received in the trash container 27.

The user starts the post-process on the shreds Sa voluntarily or when an alert indicating that the trash container 27 has been filled with the shreds Sa is displayed on the display 63 of the operation panel 60.

In this case, the user is only required to open a door 21a of the shredder casing 21, and to draw the trash container 27 out of the shredder casing 21.

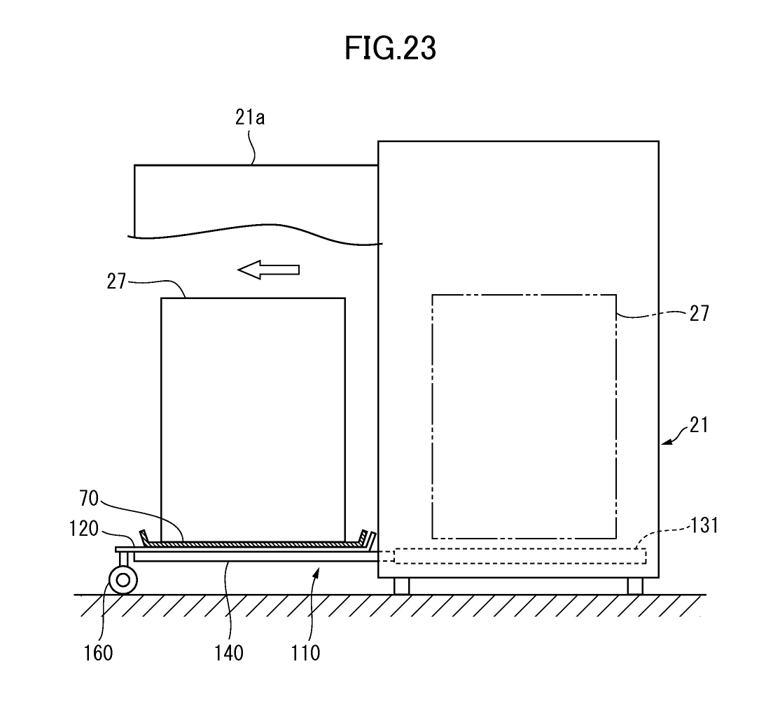

In this case, when the user draws the trash container 27 out of the shredder casing 21, as illustrated in FIG. 23, a drawing force of the user is transmitted to the trash container drawing mechanism 100 so that the mounting base 120 of the trash container drawing mechanism 100 is drawn out of the shredder casing 21 by the guide rails 130 (fixed guide rails 131 and movable guide rails 140) and the rails 150 to be guided.

In this state, on the front side in the drawing direction of the mounting base 120, the guide roller 160 rolls along the installation surface of the shredder, and hence the mounting base 120 is smoothly drawn out.

In addition, under a state in which the mounting base 120 is drawn out of the shredder casing 21, the user is only required to lift the trash container 27, and to execute a disposal process on the shreds Sa.

Further, in this embodiment, the trash container 27 is mounted on the mounting base 120 through intermediation of the tray 70, and hence the shreds Sa may fall onto the tray 70. In this embodiment, however, the tray 70 may be lifted and cleaned when the trash container 27 is lifted.

In addition, when the post-process on the trash container 27 is completed, the user is only required to mount the tray 70 on the mounting base 120 of the trash container drawing mechanism 100, mount the trash container 27 on the tray 70, and then push the trash container 27 into the shredder casing 21.

At this time, the mounting base 120 is smoothly pushed into the shredder casing 21 by the trash container drawing mechanism 100.

This embodiment has described the example in which the mounting base 120 on which the tray 70 is mounted in a separable manner is provided, but the present invention is not limited thereto. As a matter of course, a structure doubling as the tray 70 and the mounting base 120 may be employed instead.

### THIRD EMBODIMENT

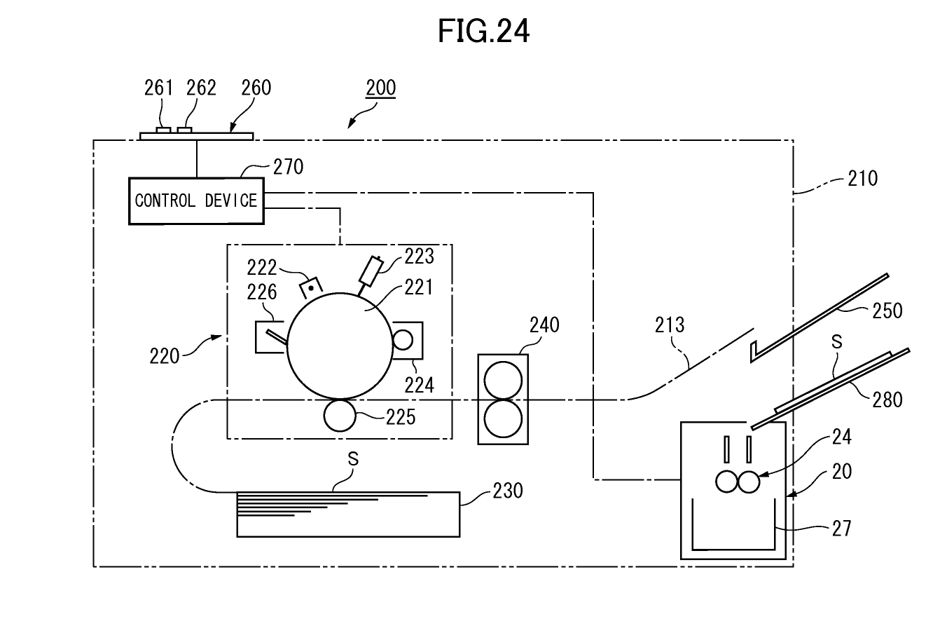

FIG. 24 is an explanatory view of a main part of an image forming apparatus according to a third embodiment of the present invention.

In FIG. 24, an image forming apparatus 200 has an apparatus casing 210 in which the shredder 20 is installed.

In this embodiment, the image forming apparatus 200 has a basic configuration in which the apparatus casing 210 includes therein an image forming unit 220 capable of forming electrophotographic images. Sheets S fed from a sheet feeding tray 230 are conveyed along a predetermined conveying path 213 up to the image forming unit 220, and images formed in the image forming unit 220 are transferred onto the sheets S. Then, the images are fixed to the sheets S by a fixing device 240, for example, of a heating-and-pressing type. Note that, a sheet receiving tray for receiving the sheets S having images formed thereon by a normal image forming process in the image forming unit 220 is denoted by the reference symbol 250.

Further, the image forming unit 220 includes, around a photosensitive member 221, a charging device 222 for charging the photosensitive member 221, an exposure device 223 for forming the electrostatic latent images on the charged photosensitive member 221, a developing device 224 for developing the electrostatic latent images formed on the photosensitive member 221 into visible images with toner, a transfer device 225 for electrostatically transferring the images (toner images), which are formed on the photosensitive member 221, onto the sheets S, and a cleaning device 226 for cleaning residual matter on the photosensitive member 221 after the transfer.

Still further, in this embodiment, with respect to the shredder 20 installed in the apparatus casing 210, a sheet guide tray 280 for guiding sheets S into the shredder 20 is provided, for example, on a lateral side of the apparatus casing 210. With this, the sheets S to be shredded are guided from the sheet guide tray 280 into the shredder 20.

Any of the shredders 20 used as in the first and second embodiments and in the modification may be used as the shredder 20 used in this embodiment.

In addition, the apparatus casing 210 includes an operation panel 260 of the image forming apparatus 200. The operation panel 260 includes not only an image forming operation portion 261 for executing the normal image forming process, but also a shredding operation portion 262 for the shredder 20 (equivalent, for example, to the operation panel 60 in the first embodiment). A control device 270 for controlling the image forming apparatus 200 in response to operations to the operation panel 260 is further provided.

Next, description is made of operation of the image forming apparatus according to this embodiment.

In FIG. 24, when the image forming operation portion 261 of the operation panel 260 is operated, the control device 270 transmits, in accordance with an image forming mode, control signals necessary for image formation to the image forming unit 220, the sheet feeding tray 230, the fixing device 240, and the conveying system for the sheets S so as to execute a series of image forming process.

On the other hand, under a state in which the sheets S to be shredded are set to the sheet guide tray 280, when the shredding operation portion 262 of the operation panel 260 is operated so that the sheets S are fed into the shredder 20, the normal shredding process on the sheets S, processes to be executed depending on whether or not the maintenance is needed, or the process in the cleaning mode is executed in accordance with demand from a user.

In this embodiment, the shredder 20 is installed in the image forming apparatus 200. Thus, there is an advantage in that, even when the image forming process by the image forming unit 220 fails to be properly executed on some of the sheets S, the shredding process can be immediately executed by the shredder 20.

What is claimed is:

1. A shredding unit for shredding a sheet-like object, the shredding unit comprising:
a shredding mechanism comprising cutter elements in a pair, which are arranged to mesh with each other, for shredding the sheet-like object conveyed into a meshing region between the cutter elements in a pair; and
a cleaning mechanism for cleaning the cutter elements in a pair to remove, from the cutter elements in a pair, particles generated through shredding in the meshing region between the cutter elements in a pair,
the shredding mechanism comprising, as each of the cutter elements in a pair:
cutter portions each having a circular shape in cross-section with cutting blades formed therearound at a predetermined pitch, the cutter portions being arranged in a plurality of stages through intermediation of spacer portions each having a circular shape in cross-section with a predetermined clearance; and
recessed portions formed between the cutter portions so that the cutting blades of the cutter portions project outward with respect to peripheries of the spacer portions,
the cutting blades of the cutter portions of one of the cutter elements in a pair meshing with the recessed portions of another of the cutter elements in a pair in a manner of biting into the recessed portions,
the cleaning mechanism comprising:
first partition members arranged in a plurality of stages in a region out of the meshing region between the cutter elements in a pair to cover the peripheries of the spacer portions of the cutter elements in a pair, the first partition members being configured to remove the particles generated through the shredding in the meshing region between the cutter elements in a pair from an inside of the recessed portions of the cutter elements in a pair; and
second partition members arranged in a plurality of stages in the region out of the meshing region between the cutter elements in a pair to cover peripheries of the cutter portions of the cutter elements in a pair, the second partition members being configured to close gaps through which the particles generated through the shredding in the meshing region between the cutter elements in a pair enter between the first partition members.

2. A shredding unit according to claim 1, wherein the shredding mechanism comprises, as the each of the cutter elements in a pair, a blade drum including the cutter portions integrally formed around a rotatable drum body by a cutting-out process through intermediation of the recessed portions each having a predetermined clearance along a direction of a rotary shaft of the rotatable drum body.

3. A shredding unit according to claim 1,
wherein the first partition members and the second partition members of the cleaning mechanism are arranged in a plurality of stages so that the first partition members and the second partition members are alternately stacked along the spacer portions and the cutter portions of the cutter elements in a pair, which are arranged in the shredding mechanism, and
wherein the first partition members and the second partition members are positioned by positioning members.

4. A shredding unit according to claim 1,
wherein each of the first partition members of the cleaning mechanism has a circular-arc edge surface conforming to a shape of a peripheral surface of each of the spacer portions of the cutter elements in a pair, and
wherein each of the second partition members of the cleaning mechanism has a circular-arc edge surface conforming to an outer peripheral edge of each of the cutting blades of the cutter portions of the cutter elements in a pair.

5. A shredding unit according to claim 1, wherein each of the first partition members and the second partition members of the cleaning mechanism comprises a plate member that bridges one half region and another half region defined across a boundary corresponding to a center position of the meshing region between the cutter elements in a pair, which are arranged in the shredding mechanism.

6. A shredding unit according to claim 1, wherein the first partition members and the second partition members of the cleaning mechanism are positioned by a common positioning member.

7. A shredding unit according to claim 1, wherein each of the first partition members and the second partition members of the cleaning mechanism is positioned at two points including a portion to be positioned, which is a pivot center, and a portion to be positioned, which is formed at a position separated from the pivot center.

8. A shredding unit according to claim 1, wherein each of the first partition members of the cleaning mechanism comprises one or a plurality of guide pieces extending downward, which are formed at a lower end edge of a part of the each of the first partition members for covering each of the peripheries of the spacer portions of the cutter elements in a pair.

9. A shredder, comprising:
a shredder casing;
a conveying path formed in the shredder casing, for conveying a sheet-like object; and
a shredding unit arranged in a midway of the conveying path, for shredding the conveyed sheet-like object,
the shredding unit comprising the shredding unit of claim 1.

10. A shredder according to claim 9, further comprising:
a trash container arranged below the shredding mechanism inside the shredder casing, for receiving shreds formed of the particles generated through the shredding by the shredding mechanism; and
a movable support mechanism for supporting the trash container so that the trash container is drawable out of the shredder casing,
the movable support mechanism comprising:
a receiving member having a tray-like shape, on which the trash container is mountable; and
a guide mechanism arranged on a bottom portion of the shredder casing, for guiding the receiving member so that the receiving member is drawable out of the shredder casing under a state in which at least a part of the guide mechanism is held in contact with an installation surface of the shredder.

11. A shredder according to claim 10, wherein the guide mechanism comprises:
a guide rail for guiding the receiving member along a drawing direction; and
a guide roller arranged on a front side in the drawing direction of the receiving member, for supporting and guiding the front side in the drawing direction of the receiving member and rolling with respect to the installation surface of the shredder when drawing the receiving member out of the shredder casing.

12. A sheet-like-object processing apparatus, comprising:
a processing unit for processing a sheet-like object; and
the shredder of claim 9 for shredding the sheet-like object that fails to be properly processed by the processing unit.
